(19) United States
(12) Patent Application Publication
(10) Pub. No.: US 2003/0154132 A1
(43) Pub. Date: Aug. 14, 2003

(54) Distribution system, terminal apparatus, distribution method, program and recording medium

(76) Inventors: Tomoki Ogawa, Hyogo (JP); Taro Katayama, Osaka (JP); Noriaki Horii, Osaka (JP)

Correspondence Address: MCDERMOTT, WILL & EMERY, 600 13th Street, N.W., Washington, DC, 20005-3096, US

(21) Appl. No.: 10/291,812

(22) Filed: Nov. 12, 2002

(30) Foreign Application Priority Data
Nov. 12, 2001 (JP) 2001-345584
Nov. 27, 2001 (JP) 2001-360543

(51) Int. Cl. G06F 17/60

(52) U.S. Cl. 705/16

(57) ABSTRACT

This invention relates to a distribution system, apparatus, distribution method, program and recording medium used buy a seller and buyer when distributing digital contents such as music, and more particularly to a distribution system, apparatus, distribution method, program and recording medium that is capable of promoting the sale of the contents. The invention provides a distribution system, apparatus, distribution method, program and recording medium that is capable of increasing the advertisement and promotional effect, relieving concentrated ordering of popular contents and increasing sales. In order to accomplish this, the invention provides a distribution system, apparatus, distribution method, program and recording medium comprising a contents memory unit stores a container that contains the received contents, and a distribution log data area that stores distribution log data capable of specifying the distribution route of the contents. Also, an additional information control unit adds identification data, which is capable of identifying the terminal apparatus, to the distribution log data area as distribution log data according to specific rules. Moreover, a personal distribution sending unit sends the container, to which the distribution log data have been added, to another terminal apparatus.

### BACKGROUND OF THE INVENTION

1. Field of the Invention

This invention relates to a distribution system, terminal apparatus, distribution method, program and recording medium used by a seller and buyer when distributing digital contents such as music, and more particularly to a distribution system, terminal apparatus, distribution method, program and recording medium that is capable of promoting the sale of the contents.

2. Description of the Related Art

Sales systems using electronic distribution of music have been proposed, developed and even put into practical use. For example, music can be purchased by inserting a memory card into a distribution apparatus that has been set up at a location such as a Kiosk at a train station or in a convenience store, and downloading a desired song over communication lines from a distribution server at a distribution center, then by inserting that memory card into a personal portable terminal, it is possible to play and enjoy the purchased music. In this kind of system, in order to promote the sale of the contents, it was necessary to advertise the provided contents and new songs. However, when starting distribution of a new popular song, there was the possibility that the electronic distribution server would become congested due to a large amount of orders and that sale of the song would be delayed or an order would not be received.

Moreover, a system was also proposed in which, when copying the purchased song from the memory card to another memory card to give to a friend, the friend would purchase a decoding key for the memory card on which the copy was stored from the distribution center by way of the station Kiosk or convenience store, and could enjoy the song by decoding the secret code for the encoded song on the memory card. This is a system that provides a route for personal sales among friends. However, for an individual, there were no benefits even though they helped in the sale of the song, so a more effective system for promoting sales was desired.

### SUMMARY OF THE INVENTION

This invention provides a distribution system, terminal apparatus, distribution method, program and recording medium that is capable of increasing the advertisement and promotional effect, relieving concentrated ordering of popular contents and increasing sales.

In order to solve the problems described above, the distribution system, terminal apparatus, distribution method, program and recording medium of this invention uses the following means.

That is, this invention provides a terminal apparatus that receives and plays distributed contents. Here, a contents memory unit stores a container that contains the received contents, and a distribution log data area that stores distribution log data capable of specifying the distribution route of the contents. Also, an additional information control unit adds identification data, which is capable of identifying the terminal apparatus, to the distribution log data area as distribution log data according to specific rules. Moreover, a personal distribution sending unit sends the container, to which the distribution log data have been added, to another terminal apparatus.

By using a terminal apparatus that is constructed in this way, it is possible to establish a personal-distribution route in addition to the supply route from the distributor, and thus it is possible to avoid concentrated orders sent to the distribution server that is installed by the distributor. Also, since information capable of specifying the distribution route is added to the container that stores the contents, it becomes possible to specify the terminal apparatus that is involved in the distribution.

It is also possible to have CM contents contained in the container.

When the container contains CM contents, CM contents are distributed through personal distribution without the distributor's knowing, so a large CM advertisement effect can be expected without any burden on the distributor (distribution server).

Moreover, construction is possible such that, when using the container, identifying information for another terminal apparatus that is stored in the distribution log data area is sent to a specified apparatus. In the case of this construction, by having the specified apparatus be an apparatus of the distributor, it becomes possible to send contents-distribution data that is an appointment issued on promotion of the distribution of the contents from the specified apparatus of the distributor to a terminal apparatus based on the conditions of use of the container of the user's own terminal apparatus or another terminal apparatus; and an application is possible in which the user (terminal apparatus) that supplied the contents can acquire sales points. By doing this, there is a greater incentive for the user, so sales promotion through personal distribution can be expected.

By including CM contents in the container, the user (terminal apparatus) can expect revenue from the sponsor, so the user's incentive is further increased.

The distribution system of this invention comprises the aforementioned terminal apparatus; a distribution server that sends a container, containing the received contents and a distribution log data area that stores distribution log data capable of specifying the distribution route of the contents, to the terminal apparatus; and a distribution data management server that allots contents-distribution data to another terminal apparatus based on received identification data for the other terminal apparatus.

Moreover, the structure of distribution in the aforementioned distribution system can be taken to be the distribution method. Furthermore, this invention can also be provided as a program distributed by way of electronic communication lines or the like. By using this program together with an apparatus comprising a CPU that controls a non-volatile memory, the apparatus can function as the aforementioned terminal apparatus. Also, this program can be distributed in the form of being recorded on a recording medium such as a CD-ROM that can be read by a computer.

### BRIEF DESCRIPTION OF THE DRAWINGS

FIG. 1 is a drawing showing the construction of the electronic distribution system and apparatus of an embodiment of the invention.

FIG. 2 is a drawing showing the construction of the electronic distribution system and apparatus of an embodiment of the invention.

FIG. 3 is a drawing showing the construction of the electronic distribution system and apparatus of an embodiment of the invention.

FIG. 4 is a drawing showing the construction of the terminal apparatus used in the electronic distribution system, apparatus and electronic distribution method of an embodiment of the invention.

FIG. 5 is a drawing showing the container used in the electronic distribution system, apparatus and electronic distribution method, and the contents of the contents memory unit of an embodiment of the invention.

FIG. 6 is a flowchart showing the procedure of the electronic distribution method of an embodiment of the invention.

FIG. 7 is a flowchart showing the procedure of the electronic distribution method of an embodiment of the invention.

FIG. 8 is a flowchart showing the procedure of the electronic distribution method of an embodiment of the invention.

FIG. 9 is a drawing showing the construction of the terminal apparatus used in the procedure of the electronic distribution method of an embodiment of the invention.

FIG. 10 is a drawing showing the construction of the electronic distribution system and apparatus of an embodiment of the invention.

FIG. 11 is a drawing showing the construction of the electronic distribution system and apparatus of an embodiment of the invention.

FIG. 12 is a drawing showing the construction of the electronic distribution system and apparatus of an embodiment of the invention.

FIG. 13 is a drawing showing the construction of the terminal apparatus used in the electronic distribution system, apparatus and electronic distribution method of an embodiment of the invention.

FIG. 14 is a drawing showing the construction of the terminal apparatus used in the electronic distribution system, apparatus and electronic distribution method of an embodiment of the invention.

FIG. 15 is a drawing showing the container used in the electronic distribution system, apparatus and electronic distribution method, and the contents of the contents memory unit of an embodiment of the invention.

FIG. 16 is a drawing showing the contents of additional CM tables (A) and (B) that are used in the electronic distribution system, apparatus and electronic distribution method of an embodiment of the invention.

FIG. 17 is a drawing showing the contents of an additional CM table (C) that is used in the electronic distribution system, apparatus and electronic distribution method of an embodiment of the invention.

FIG. 18 is a drawing showing the container used in the electronic distribution system, apparatus and electronic distribution method, and the contents of the contents memory unit of an embodiment of the invention.

FIG. 19 is a flowchart showing the procedure of the electronic distribution method of an embodiment of the invention.

FIG. 20 is a flowchart showing the procedure of the electronic distribution method of an embodiment of the invention.

FIG. 21 is a flowchart showing the procedure of the electronic distribution method of an embodiment of the invention.

FIG. 22 is a flowchart showing the procedure of the electronic distribution method of an embodiment of the invention.

FIG. 23 is a drawing showing the construction of the terminal apparatus used in the procedure of the electronic distribution method of an embodiment of the invention.

### DESCRIPTION OF THE PREFERRED EMBODIMENTS

(1-1) Embodiment 1 of the Electronic Distribution System and Apparatus

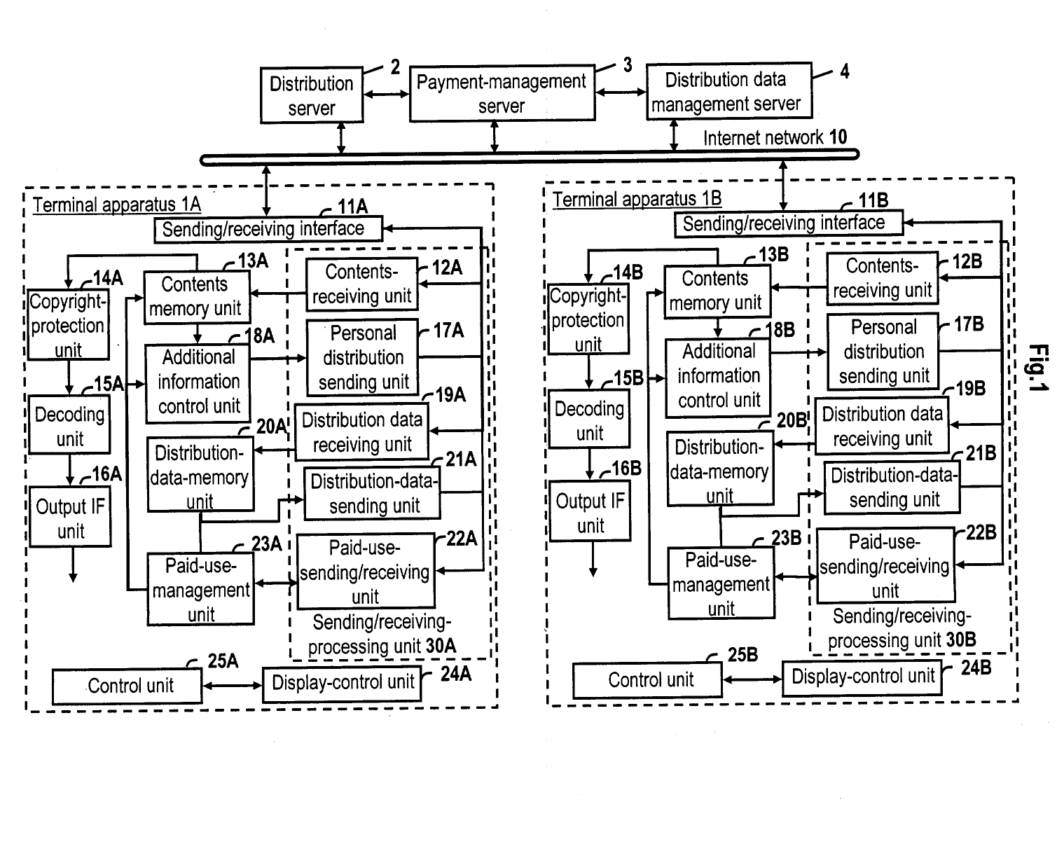

FIG. 1 is a block diagram of a first embodiment of the electronic distribution system of this invention. In FIG. 1, the electronic distribution system comprises a distribution server 2, payment-management server 3, distribution data management server 4, Internet network 10, terminal apparatus 1A and terminal apparatus 1B.

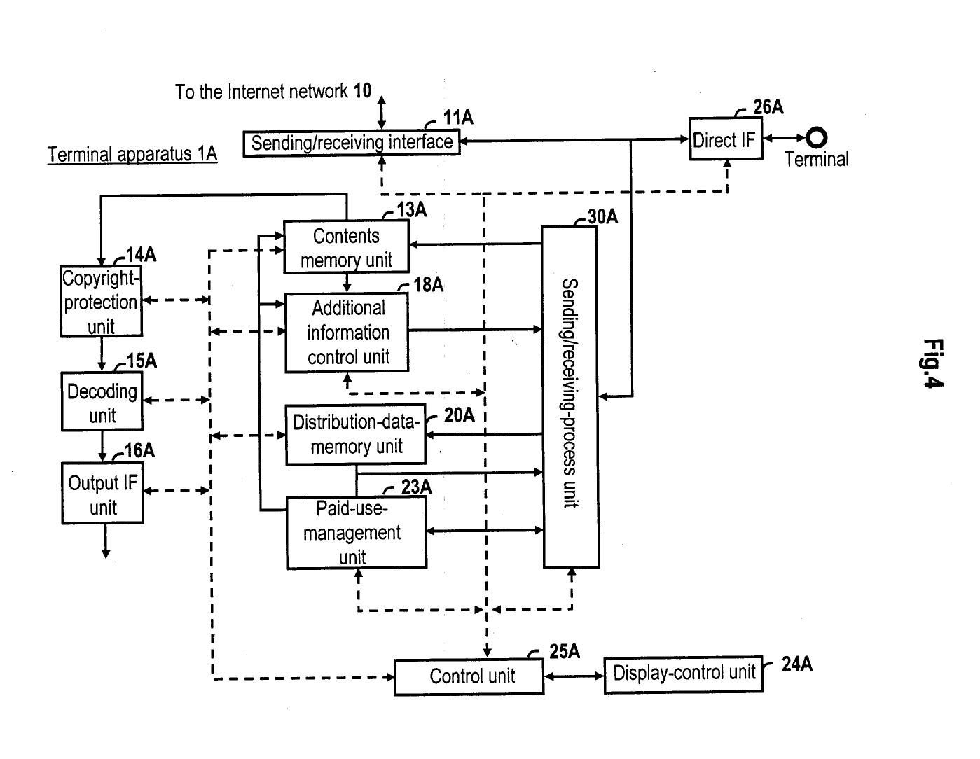

Terminal apparatus 1A further comprises a sending/receiving interface 11A, contents-receiving unit 12A, contents memory unit 13A, copyright-protection unit 14A, decoding unit 15A, output IF unit 16A, personal distribution sending unit 17A, additional-data-control unit 18A, distribution data receiving unit 19A, distribution-data-memory unit 20A, distribution-data-sending unit 21A, paid-use-sending/receiving unit 22A, paid-use-management unit 23A, display-control unit 24A and control unit 25A. As shown by the dashed line in FIG. 4, the control unit 25A connects all of the other construction elements, and sends and receives control data between each of the construction elements to control each of the elements and perform overall control. The construction of terminal apparatus 1B is the same. Instead of A, B is given to the numbers for the construction elements of terminal apparatus 1B.

The distributor of the digital contents such as music has and manages the distribution server 2, payment-management server 3 and distribution data management server 4, and performs distribution of the contents. The distributor makes a distribution contract with the user A, who has terminal apparatus 1A, and receives a distribution order for music or the like from user A and sends the contents corresponding to the order to the terminal apparatus 1A of user A.

Also, the method of settling the fee for the contents is decided with the user A beforehand, and the payment-management server 3 manages the fee based on that decision and the order. The distributor makes a similar distribution contract with user B that owns terminal apparatus 1B, and makes distribution contracts with a plurality of other users having terminal apparatuses, and performs the work of distributing the music (contents). The distribution data management server 4 issues and performs overall management of distribution data for promoting distribution.

First, the user A uses display control panel 24A on the terminal apparatus 1A to enter (select) a desired song title M from among the available songs and makes an order. The control unit 25A gives the song title M over to the paid-use-management unit 23A and instructs that an order be processed. The paid-use-management unit 23A adds the ID of the terminal apparatus 1A and the address of the distribution server 2 to the song title M and creates an order form and gives it over to the paid-use-sending/receiving unit 22A. Here, the ID is identification information that can specify the terminal apparatus. The paid-use-sending/receiving unit 22A uses the order form to create data according to the protocol for transmission over the Internet, and gives the data to the sending/receiving interface 11A. The sending/receiving interface 11A establishes a communication line with the distribution server 2 and sends the order form containing the ID of the terminal apparatus 1A and song title M to the distribution server 2 via the Internet network 10.

The distribution server 2 checks the ID of the terminal apparatus 1A and by way of the established communication line, puts the contents corresponding to the ordered song title M in a container and returns it. The container will be described in detail later.

After the sending/receiving interface 11A receives the container, it checks the received contents and when it confirms that the container contains the proper contents it gives the container to the contents-receiving unit 12A. The contents-receiving unit 12A checks to make sure the received contents are contents that correspond to the ordered song title M, and stores the contents as they are in the container in the contents memory unit 13A. The control unit 25A receives a notice from the content-receiving unit 12A that the ordered contents have been received, and then sends an instruction to the paid-use-management unit 23A, and the paid-use-management unit 23A follows the instruction and notifies the distribution server 2 via the paid-use-sending/receiving unit 22A and sending/receiving interface 11A that the ordered song title M was received properly.

The distribution server 2 receives the notice that the contents have been properly received and instructs the payment-management server 3 to settle the account. The payment-management server 3 executes the account settlement procedure according to the settlement decision. The account settlement procedure is a procedure for withdrawing the money for the contents from the bank account of user A, for example.

The contents data of this invention are stored in a container and then distributed. The container contains the contents and additional information that is inseparably related to the contents, and these contents can have the status ‘Paid’ or ‘Unpaid’. Various formats are possible for taking the status, ‘Paid’ or ‘Unpaid’, and details of the format used in this invention will be described in detail later.

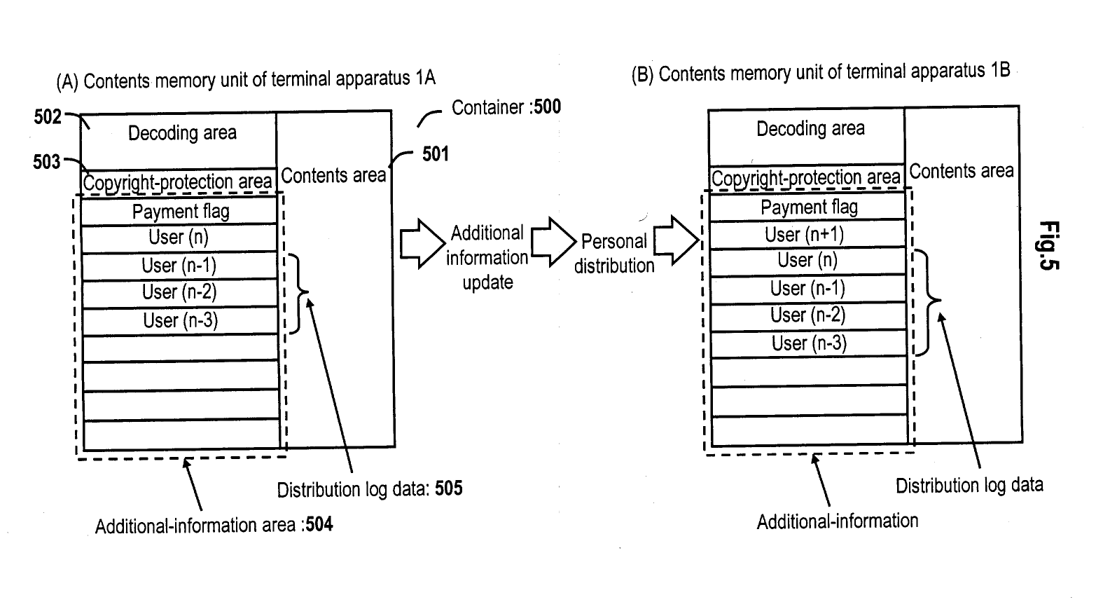

An example of the information contained in the container is shown in FIG. 5(A). In FIG. 5(A), the container 500 comprises a contents area 501 that stores the music data, a decoding area 502 that stores a decoding program for decompressing and decoding the compressed and coded contents, a copyright-protection area 503 that stores information related to copyright protection of the contents, and an additional-information area 504. However, the decoding area 502 is not necessarily required.

The contents area 501 stores the music (contents) corresponding to the ordered song title M as compressed data. Decoding software, or in other words, software for decompressing the compressed data, is stored in the decoding area 502. The copyright-protection area 503 stores copyright protection information, and this copyright protection information includes information related to: conditions of use such as the number of times the song title M can been ordered, or the number of times copying is allowed, the owner of the copyright, and information related to the past copies. The additional-information area 504 stores information such as a payment flag indicating whether or not the stored contents have already been paid for, and distribution log data, which is information related to the users who have used the contents. In other words, the fee information and distribution-log information can be called additional information. The payment flag mentioned above is ‘0’ when the fee has not yet been paid, and is ‘1’ when the fee has been paid. In the case of these contents, the fee has already been processed, so the distribution server 2 creates and sends a payment flag, and that payment flag is ‘1’, indicating that the fee has already been paid. Also, the distribution-log-information area 505 for the contents supplied from the distribution server 2 is in the empty state. By searching the distribution-log information, it is possible to specify the distribution route for the contents terminal even when the contents (container) are distributed personally as will be described later.

In order to listen to the ordered song, the user A operates the display-control unit 24 and gives an instruction to play the song. According to the instruction from the display-control unit 24A, the control unit 25A sends the contents from the contents memory unit 13A to the copyright-protection unit 14A, and performs the copyright-protection process based on copyright-protection information. Since the payment flag for the contents received by the terminal apparatus 1A is ‘1’, the copyright-protection process gives permission to play the contents. After permission has been to play the contents, the decoding unit 15A decodes the contents and outputs the music signal from the output IF unit 16A. The copyright-protection unit 14A and decoding unit 15A can also be called the contents-operation unit that controls specific operations on the contents. In this way, the user A is able to enjoy listening to the music being played.

Using the same procedure as in the case of terminal apparatus 1A, user B can use terminal apparatus 1B to order, purchase and listen to contents corresponding to a song title M.

In the electronic distribution system of this invention, it is possible to distribute contents between a plurality of terminal apparatuses, such as between terminal apparatus 1A and terminal apparatus 1B.

In other words, supposing user A and user B are friends, for example, and user B listens to the contents purchased by user A and also wants to purchase the contents, user A can distribute the purchased contents from terminal apparatus 1A to terminal apparatus 1B. This is called personal distribution. After user B performs the procedure for purchasing the received contents, user B can then enjoy the contents on his/her own terminal apparatus 1B.

Various methods are possible as the method for personal distribution, however, as an example, a method of using an attached e-mail file will be explained. User A enters the address of the terminal apparatus 1B of user B and the song title M of the contents desired by user B. The control unit 25A reads the container in the contents memory unit 13A and the additional information control unit 18A sets the payment flag to ‘0’. In other words, the container is set to the ‘Unpaid’ state. Furthermore, the additional-information unit 18A adds the ID of the terminal apparatus A to the distribution-log information 505 in the container, and gives ‘Unpaid’ container to a contents-sending unit having a function for sending the contents, or in other words, a personal distribution sending unit 17A. The personal distribution sending unit 17A creates an e-mail for the address of the terminal apparatus 1B, adds the container and sends a request to the sending/receiving interface 11 to send the e-mail. The sending/receiving interface 11A calls the contracted Internet service provider (not shown in the figure) via a dial-up connection, for example, establishes a communication line and requests that the e-mail be sent.

Here, the reason the payment flag is set to ‘0’ is to prevent copying of the contents and playing the contents for free.

The e-mail for personal distribution is stored by the Internet service provider. The user B connects the terminal apparatus 1B with a contracted Internet service provider using a Dial-up connection, and by using the terminal apparatus 1B to execute a process for obtaining the e-mail, the e-mail is sent to the terminal apparatus 1B. At the terminal apparatus 1B, the sending/receiving interface 11B that received the e-mail detects that the received contents is an e-mail and that the attached file is a container, then gives that container over to the contents-receiving unit 12B. The contents-receiving unit 12B receives the container and stores it in the contents memory unit 13B.

The user B that received the contents in the sent container uses the display-control unit 24B to enter confirmation that the personally distributed contents have been purchased. The display-control unit 24B can also include a control such as a proof-of-purchase button. The control unit 25B sends the song title M to the paid-use-management unit 23B and instructs that an order for personal distribution be performed. The paid-use-management unit 23B creates a personal-distribution order form by adding the ID of the terminal 1B, the address of the payment-management server 3, and ID of the terminal apparatus 1A, which is the personal-distribution source, to the song title M, and sends the form to the paid-use-sending/receiving unit 22B. Here, the ID of terminal apparatus 1A, which is the personal-distribution source, is obtained from the ID that was added to the distribution-log information 505 in the received container. The paid-use-sending/receiving unit 22B uses the form to create data according to the protocol for Internet transmission, and sends the data to the sending/receiving interface 11B. The sending/receiving interface 1B establishes a communication line with the payment-management server 3, and sends the order form, which contains the ID of terminal apparatus 1B, the song title M, and ID of the personal-distribution source or terminal apparatus 1A, to the payment-management server 3 via the Internet network 10.

After the payment-management server 3 receives the order form, it checks the ID for terminal 1B, and reports the purchase for personal distribution of the ordered song title M to the distribution server 2. Also, the payment-management server 3 performs the procedure for making a withdrawal from the bank account of user B, and sends the key K for the purchased song title M. Here, the key gives permission to play the contents that correspond to the ordered song title M. It is preferred that this key give permission to play only the ordered song title M.

Next, the payment-management server 3 sends the ID of the terminal apparatus 1A, which is the personal-distribution source in this case, to the distribution data management server 4, and requests that the contents distribution data, for example, the sales point, be sent to terminal apparatus 1A. The distribution data management server 4 receives the request and sends the sales point to terminal apparatus 1A. The sales point will be described in detail later.

After terminal apparatus 1B receives the payment-complete key K, the sending/receiving interface 11B checks the received contents, and when it detects that the payment-complete key K has been received, it sends the key to the paid-use-sending/receiving unit 22B. The paid-use-sending/receiving unit 22B gives the received payment-complete key K to the paid-use-management unit 23B. The paid-use-management unit 23B uses the payment-complete key K to change the fee data, or in other words the payment flag, in the container stored in the contents memory unit 13B from ‘0’ to ‘1’. This process sets the status to ‘Paid’.

After the payment flag changes from ‘0’ to ‘1’, it becomes possible to play the contents that correspond to the song title M. When user B uses the display-control unit 24B to give an instruction to start playing the song title M, the control unit 25B sends the copyright information and payment flag from the contents memory unit 13B to the copyright-protection unit 14B, and the copyright-protection unit 14B performs the copyright protection process. Since the payment flag is ‘1’, the copyright-protection unit 14B, through the copyright protection process, allows playing of the song. In other words, it sends the contents and decoding software to the decoding unit 15B, and the decoding unit 15B decodes the contents and outputs a music signal from the output IF unit 16B. The copyright-protection unit 14B and decoding unit 15B make up the contents-operation unit that performs specific operations on the contents. Now, user B can enjoy playing and listening to the music.

When the terminal apparatus 1A receives the sales point send from the distribution data management server 4, the sending/receiving interface 11A of the terminal apparatus 1A checks the contents. Since the received content is a sales point, the sending/receiving interface 11A gives the sales point to the distribution data receiving unit 19A. The distribution data receiving unit 19A stores the received sales point in the distribution-data-memory unit 20A. The newly received sales point is added to the sales points that have been stored previously.

The contents distribution data, or in other words, the sales point, is used in order to receive a price discount service when a user orders a new song, for example. To send or receive a sales point, it is possible to create a point form for storing the sales point, and to send or receive that point form. The point form could store one point, or could store multiple points.

Next, the case of when the user A uses the sales point will be explained. When the user A uses the display-control unit 24A of the terminal apparatus 1A to enter a different desired song title N, the control unit 25A sends that song to the paid-use-management unit 23A, and together with giving an instruction to make an order, checks whether or not the sales point remains in the distribution-data-memory unit 20A. When the sales point remains, the control unit 25A gives an instruction that the sales point be attached to the song title N. The paid-use-management unit 23A adds the ID of the terminal apparatus 1A and the address of the distribution server 2 to the song title N, and creates an order form, then sets a sales-point flag in the sale-point field of the order form and sends it to the paid-use-sending/receiving unit 22A. The paid-use-sending/receiving unit 22A uses the form to create data according to the protocol for Internet transmission, and sends the data to the sending/receiving interface 11A. The sending/receiving interface 11A establishes a communication line with the distribution server 2 and sends the order form, which contains the IF of the terminal apparatus 1A and song title N, to the distribution server 2 via the Internet network 10. The control unit 25A decreases the number of sales points in the distribution-data-memory unit 20A by one point, for example.

The number of sales points that can be used is a fixed number for the contents ordered, for example, one point or two or more points, and can be freely determined by the user A for the song of the ordered contents, or can be pre-determined by the distributor for the song of the ordered contents. In the case that the number of sales points is pre-determined for a song, the terminal apparatus 1A notifies the distribution server 2 of the ordered song, and the distribution server 2 then notifies the terminal apparatus 1A of the number of required points P. The terminal apparatus 1A then takes the required number of points P from the sales points saved by the terminal apparatus 1A and attaches them to the order form. The control unit 25A decreases the number of sales points in the distribution-data-memory unit 20A by the number of attached points.

The distribution server 2 makes sure that the ID of the terminal apparatus 1A and sales-point flag are set, and instructs the payment-management server 3 to subtract one sales point or the number of attached sales points from the sales price and to withdraw the remaining cost from the bank account of user A. Also, the distribution server 2 distributes the contents corresponding to the ordered song title N to the terminal apparatus 1A. However, it is preferred that the money be withdrawn from the bank account after the terminal apparatus 1A confirms that the contents have been properly received.

It is possible for the user B of terminal apparatus 1B to use terminal apparatus 1B to further personally distribute the song title M obtained through personal distribution from user A to the terminal apparatus 1C of another friend C, and to obtain sales points. It is also possible for terminal apparatus 1A to personally distribute contents obtained through personal distribution from another terminal apparatus to other terminal apparatuses.

When the user performs personal distribution in this way, he/she acquires sales points and can receive a discount on the purchase of a song, so the user actively tries to personally distribute songs among friends. For the distributor, the number of sales through personal distribution by the user can be added to the number of songs or contents sold directly to the user from the distribution server 2. For personal distribution, there is no need to send contents from the distribution server 2, so the processing capacity of the distribution server 2 does not need to be increased. Since it is possible to avoid a large concentration of orders, it is possible to more quickly distribute the ordered contents. The amount of data for sending the payment-complete key J from the payment-management server 3, and for sending sales points from the distribution data management server 4 is relatively small compared to the amount of data of the contents and does not place a burden on the server. Therefore, the distributor can expect an increase in sales with hardly having to increase investment in equipment such as the server.

Furthermore, it is also possible for the distribution-management server 4 to issue sales points and send them to terminal apparatus 1A by way of terminal apparatus 1B. In this case, the sending/receiving interface 11B detects that sales points are received together with the payment-complete key K, and sends the received contents for the sales points to the distribution data receiving unit 19B. The control unit 25B temporarily stores the received sales points in the distribution-data-memory unit 20B, and instructs the distribution-data-sending unit 21B to create and send an e-mail addressed to terminal apparatus 1A, which is the personal distribution source. The distribution-data-sending unit 21B adds sales points to the e-mail addressed to terminal apparatus 1A, and sends the e-mail to the sending/receiving interface 11B. The sending/receiving interface 11B starts the e-mail software, establishes a communication line with the Internet service provider and sends the received e-mail to terminal apparatus 1A.

(1-2) Embodiment 2 of the Electronic Distribution System and Apparatus

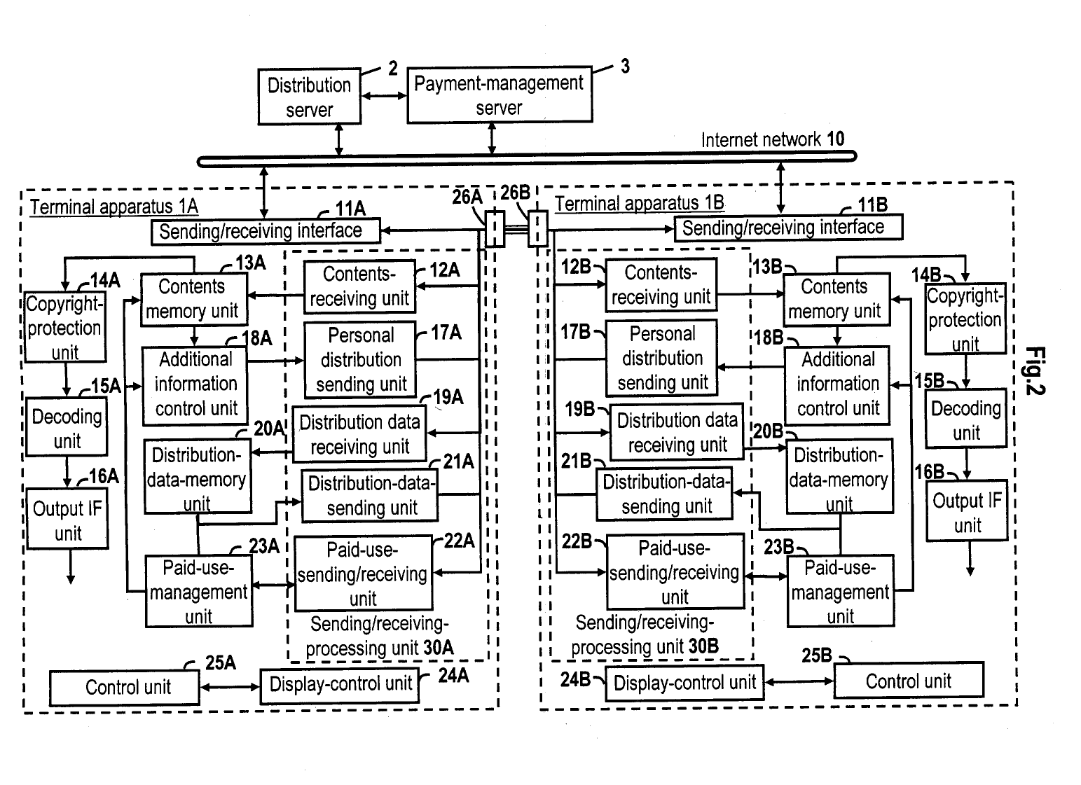

FIG. 2 is a block diagram of a second embodiment of the electronic distribution system of this invention.

This explanation will center on the parts of this embodiment that differ from the embodiment shown in FIG. 1. In FIG. 2, this embodiment differs from the first embodiment in that the distribution data management server 4 has been omitted. Also, a direct interface 26A is installed in the terminal apparatus 1A, and a direct interface 26B is installed in terminal apparatus 1B. Direct interface 26A and direct interface 26B are connected by a cable such that communication between them is possible.

Personal distribution from terminal apparatus 1A to terminal apparatus 1B is performed between direct interface 26A and direct interface 26B. When performing personal distribution, the user A uses the display-control unit 24A to enter the song of the contents desired by user B from among contents that are stored in the contents memory unit 13A. The control unit 25A reads the container that contains the contents or song title M from the contents memory unit 13A, and by the additional information control unit 18A sets the payment flag to ‘0’, and further adds the ID of terminal apparatus 1A to the distribution log data 505 in the container and send the container to the personal distribution sending unit 17A. The personal distribution sending unit 17A outputs the container to the direct interface 26A.

At terminal apparatus 1B, the direct interface 26B receives the container and identifies the received contents and detects that the contents are the desired song title M, then sends the container to the contents-receiving unit 12B. The content-receiving unit 12B receives the container and stores it in the contents memory unit 13B. With the process described above, the user B receives the contents and performs confirmation of payment for the personally distributed contents in the same way as was done in embodiment 1.

As was done in embodiment 1, the payment-management server 3 reports the purchase record for the ordered song, performs the procedure for withdrawing the payment from the bank account of user B, and sends the payment-complete key K for the ordered song to terminal apparatus 1B. Sales points are issued by terminal apparatus 1B so there is no need for the distribution data management server 4.

After the terminal apparatus 1B receives the payment-complete key K from the payment-management server 3, the control unit 25B changes the payment flag from ‘0’ to ‘1’ and instructs the distribution-data-sending unit 21B to issue sales points and to output them from the direct interface 26B.

In the process described above, sales points are sent after the payment-complete key K has been received, so no improper state occurs such as obtaining sales points without making any payment.

Next, after terminal apparatus 1A receives the sales points that were sent from terminal apparatus 1B by way of direct interface 26A, direct interface 26A detects that the received contents are sales points and gives the received contents to the distribution data receiving unit 19A. The distribution data receiving unit 19A stores the received sales points in the distribution-data-memory unit 20A. Storage of the sales points is such that the newly received sales points are added to the previously stored sales points.

The other processing of this embodiment is the same as that explained for embodiment 1.

It is also possible to perform communication between terminal apparatus 1A and terminal apparatus 1B by close-range wireless communication. In this case of this embodiment as well, similar to the case of embodiment 1, an increase in sales can be expected due to personal distribution. Also, since communication is performed directly without having to use an Internet service provider, there is no service fee for the use of the Internet service provider. In the case of connection using a cable, there is also no need for specifying the address of the other party's terminal apparatus, as was necessary in the case of using e-mail. Furthermore, there is no need for the distribution data management server 4. In this case, user A and user B cannot perform personal distribution without bringing terminal apparatus 1A and terminal apparatus 1B together and meeting together, however the system could be made more simple.

(1-3) Embodiment 3 of the Electronic Distribution System and Apparatus

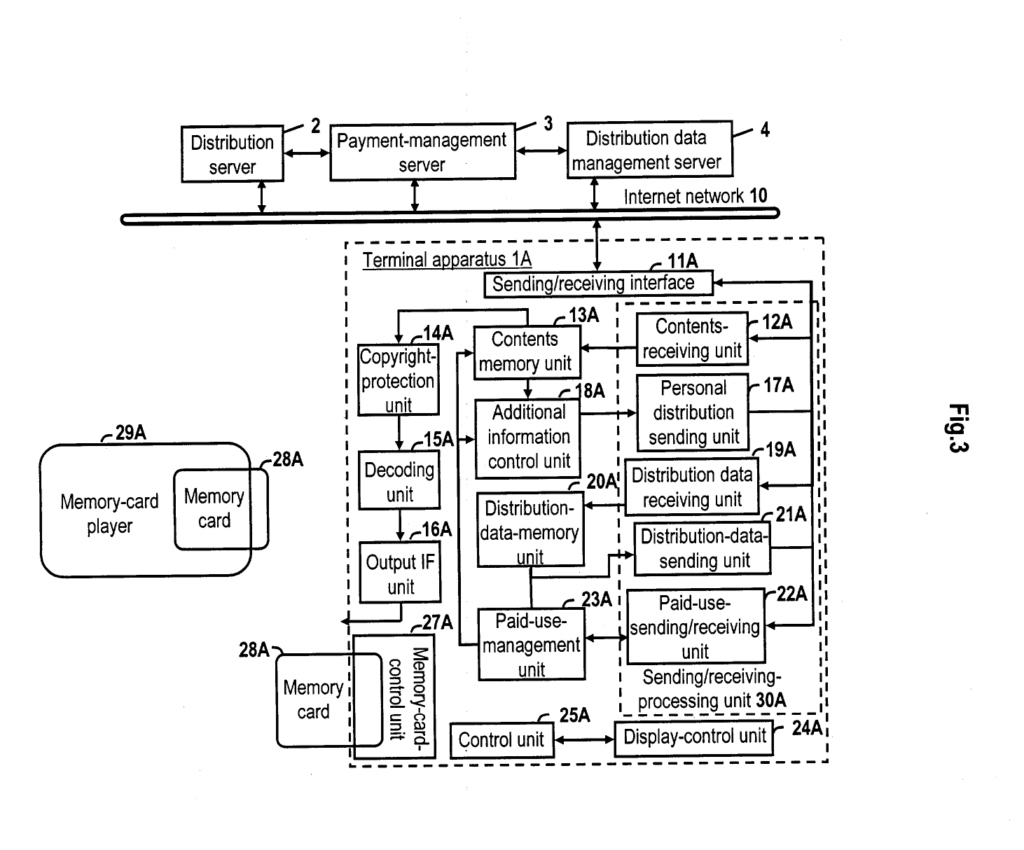

FIG. 3 is a block diagram of a third embodiment of the electronic distribution system of this invention.

In FIG. 3, in addition to the construction of the embodiment shown in FIG. 1, terminal apparatus 1A comprises a memory-card-control unit 27A.

When a memory card 28A is inserted into the memory-card-control unit 27A, the control unit 25A copies the contents in the contents memory unit 13A onto the memory card 28A via the memory-card-control unit 27A. The contents (container) on the memory card can be played by inserting the memory card 28A into a memory-card player 29A. By having the memory-card player 29A comprise a memory-card-reading-control unit, and the same copyright-protection unit 14A, decoding unit 15A, output IF unit 16A and control unit 25A as in the terminal apparatus 1A, it can play the contents in the same way as the terminal apparatus 1A. Terminal apparatus 1A can also be a personal computer that is capable of recording onto a memory card.

(1-4) Embodiment 4 of the Electronic Distribution System and Apparatus

FIG. 4 is a block diagram of another example of the main parts of the terminal apparatus using in this invention. In FIG. 4, the sending/receiving-control unit 30A integrates the contents-receiving unit 12A, personal distribution sending unit 17A, distribution data receiving unit 19A, distribution-data-sending unit 21A and paid-use-sending/receiving unit 22A that were explained for the embodiment above, and integrates the processes for sending and receiving between the distributor and terminal apparatuses performed by each of the sending/receiving units, and the sending/receiving interface 11A performs the process of establishing a line with an external communication line.

(1-5) Embodiment 1 of the Electronic Distribution Method

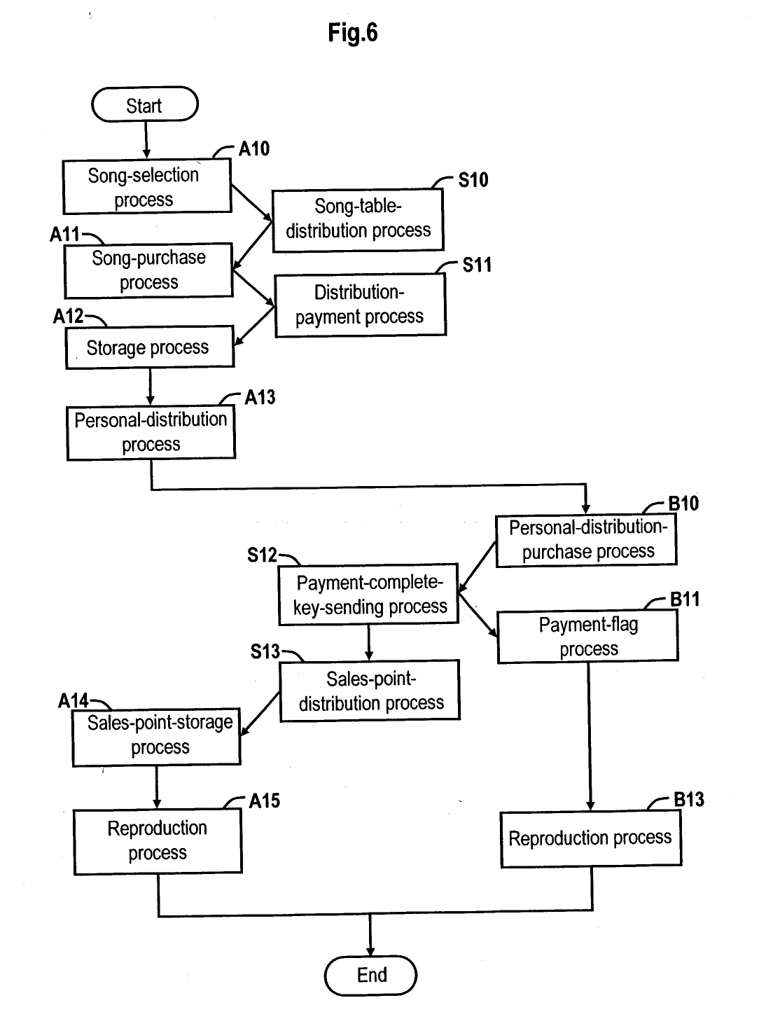

FIG. 6 is a flowchart of a first embodiment of the electronic distribution method of this invention, and shows the method of performing the functions of the electronic distribution system explained using FIG. 1. As is shown in FIG. 1, the electronic distribution system comprises a distribution server 2, payment-management server 3, distribution data management server 4, Internet network 10, terminal apparatus 1A and terminal apparatus 1B.

A distributor of digital contents such as music has a distribution server 2, payment-management server 3 and distribution data management server 4 and performs the work of distribution. The distributor makes a distribution contract with a user A that is the owner of a terminal apparatus 1A, and by way of the distribution server 2, receives a distribution order for music from the user A and sends the contents corresponding to the ordered song to the terminal apparatus 1A of the user A.

Also, the distributor decides in advance a method of settling payment with the user A for distribution, and the payment-management server 3 manages payment based on that decision and the order. The distributor also makes a contract with a user B that owns a terminal apparatus 1B, and performs the work of distributing music. In order to promote distribution, the distribution data management server 4 manages issuing of circulation data, and performs overall management of distribution data.

Next, FIG. 6 will be used to explain the electronic distribution method. In FIG. 6, the process numbers on the left side (numbers beginning with A) are processes performed by the terminal apparatus 1A, the process numbers in the middle (numbers beginning with S) are server processes performed by the distributor's server, and the process number on the right side (numbers beginning with B) are processes performed by the terminal apparatus 1B.

When user A wants to receive music, he/she uses the terminal apparatus 1A and, in the music-selection process (A10), sends a request to the distribution server 2 to distribute a list of songs.

In the song-list-distribution process (S10), the distribution server 2 distributes a list of songs to the terminal apparatus 1A. Terminal apparatus 1A receives and displays the list of songs, and the user A select a song title M from the list. Next, in a song-purchase process (A11), the paid-use-management unit 23A creates an order form that contains the ID of the terminal apparatus 1A and the address of the distribution server 2, and the paid-use-sending/receiving unit 22A uses the form to create data according to the protocol used for Internet transmission. Then, the sending/receiving interface 11A establishes a communication line with the distribution server 2 and sends the order form to the distribution server 2 via the Internet network 10.

Next, the distribution server 2, in the distribution-payment process (S11), checks the ID of the terminal apparatus 1A, and by way of the established communication line, stores the contents corresponding to the ordered song title M in a container and sends the container to terminal apparatus 1A.

After receiving the container, the terminal apparatus 1A, in the storage process (A12), checks the received contents to make sure it is the ordered contents, and after it confirms that the received contents are contents corresponding to the ordered song title M, stores the container, and notifies the distribution server 2 that the ordered song title M was received.

In the distribution-payment process (S11), the distribution server 2 instructs the payment-management server 3 to execute settlement. The payment-management server 3 executes the settlement procedure according to the settlement decision. Execution of the settlement procedure is withdrawing the payment from the bank account of the user 1A, for example. The contents in this invention are the same as explained in FIG. 5(A).

In order to listen to the contents corresponding to the ordered song title M, the user A operates the terminal apparatus 1A and, in a reproduction process (A15), the terminal apparatus 1A reads the copyright-protection information and payment flag from the stored container, and when the payment flag is ‘1’, performs the copyright-protection process to allow playing of the song title M. Next, using the decoding software, the terminal apparatus 1A decodes the contents and output a music signal. By the processes described above, user A is able to enjoy the music. When the user A want to play the contents, the reproduction process (A15) is not limited to the position shown in the flowchart, but can be executed at a desired step.

Also, using the same procedure as in the case of terminal apparatus 1A, user B can use terminal apparatus 1B to order, purchase and listen to song title M or any other desired song.

In the electronic distribution system of this invention, it is possible to distribute contents among a plurality of terminal apparatuses, for example, between terminal apparatus 1A and terminal apparatus 1B.

For example, in the case that user A and user B are friends, and user B listens to the contents purchased by user A and also wants to purchase those contents, user A can distribute the purchased contents from terminal apparatus 1A to terminal apparatus 1B. This is called personal distribution. User B can then listen to the music after performing payment procedures for the received contents.

Various methods can be used as the method for personal distribution, however, as one example, the case of attaching the contents as an e-mail attachment file will be explained. When user A uses terminal apparatus 1A to enter the address of terminal apparatus 1B and the song title M of the contents desired by user B, in a personal-distribution process (A13), the terminal apparatus 1A reads the container and sets the payment flag to ‘0’, to set the payment status of the container to ‘Unpaid’. In addition, the terminal apparatus 1A adds the ID of terminal apparatus 1A to the distribution-log information 505 in the container, then creates an e-mail addressed to terminal apparatus 1B and attaches the container. Next, terminal apparatus 1A make a dial-up connection and calls the contracted Internet service provider, then establishes a communication line and requests that the e-mail be sent. The reason the payment flag is set to ‘0’ is to prevent playing the song free of charge.

The personally distributed e-mail is temporarily stored by the Internet service provider. User B uses terminal apparatus 1B to make a dial-up connection with a contracted Internet service provider, and by executing a process for obtaining the e-mail, the e-mail is sent to terminal apparatus 1B. After receiving the e-mail, terminal apparatus 1B, in a personal-distribution-purchasing process (B10), detects that the received contents is an e-mail, and that the attached file is a container, and then stores the container in the contents memory unit.

Next, after user B receives the contents, he/she operates terminal apparatus 1B to enter proof of purchase of the personally distributed contents. Terminal apparatus 1B, in the personal-distribution-purchasing process (B10), creates an order form that contains the song title M, the ID of terminal apparatus 1B, the address of the payment-management server 3, and the ID of terminal apparatus 1A, which is the personal-distribution source. Next, using the form, terminal apparatus 1B creates data according to protocol for Internet transmission, then establishes a communication line with the payment-management server 3 and sends the order form to the payment-management server 3 via the Internet network 10.

After the payment-management server 3 receives the order form, in a payment-complete-key-sending process (S12), check the ID of terminal apparatus 1B and sends a report of the payment record for the ordered song title M to the distribution server 2. Then, the payment-management server 3 performs the procedure of withdrawing the payment from the bank account of user B, and sends the payment-complete key K for the ordered song to terminal apparatus 1B. The payment-complete key K is a key that gives permission to play the ordered song title Next, the payment-management server 3 sends the ID of terminal apparatus 1A, which is the personal-distribution source for this transaction, to the distribution data management server 4, and requests that distribution data for the contents, for example, sales points, be sent to terminal apparatus 1A. In the sales-point-distribution process (S13), or by a different name, distribution-data-sending process or contents-distribution-data-sending process, the distribution data management server 4 receives the request and sends sales points to terminal apparatus 1A. The sales points are the same as has already been explained.

After terminal apparatus 1B receives the payment-complete key K, terminal apparatus 1B, in a payment-flag process (B11), or by a different name, payment-data process, checks the received contents, and detects that the payment-complete key K had been received, then uses the received payment-complete key K to change the payment flag in the container from ‘0’ to ‘1’. This process makes sets the payment status of the container to ‘Paid’.

After the payment flag changes from ‘0’ to ‘1’, it becomes possible to play the ordered song title M. User B uses terminal apparatus 1B to give an instruction to start playing the ordered song title M, and, in the reproduction process (B13), terminal apparatus 1B obtains the copyright information and payment flag, and performs the copyright-protection process. Since the payment flag is ‘1’, the copyright-protection process gives permission for playing of the song title M. Next, terminal apparatus 1B uses the decoding software to decode the contents and outputs a music signal. With the processes described above, user B is able to enjoy the music.

After terminal apparatus A receives the sales points that were sent from the payment-management server 3, in a sales-point-storage process, or by another name, distribution-data-storage process, the terminal apparatus 1A detects that the received contents are sales points, and stores the received sales points. Storage is performed by adding the newly received sales points to the previously stored sales points. As already explained, the sales points can be used for receiving a sales discount service.

In the song-purchasing-process (A11) shown in FIG. 6, when the user A uses the terminal apparatus 1A to enter the desired song title N, the terminal apparatus 1A check whether or not there are any sales points remaining, and when there are remaining sales points, adds a sales points to the order form. Next, the terminal apparatus 1A creates an order form that contains the song title N, the ID of terminal apparatus 1A and the address of the distribution server 2, then sets a flag indicating the use of sales points in the sales point column of the order form, and uses that form to create data according to the protocol for Internet transmission. After that, the terminal apparatus 1A establishes a communication line with the distribution server 2 and sends the order form to the distribution server 2 via the Internet network 10. Also, the number of sales points stored in memory is decreased by the number of sales points used.

In the distribution-payment process (S11), the distribution server 2 checks the ID of the terminal apparatus 1A and that the flag indicating the use of sales points is set, then instructs the payment-management server 3 to subtract the amount of sales points used 1 from the sales price and to withdraw the remaining payment from the bank account of user A. Also, the distribution server 2 sends the contents corresponding to the ordered song title N to the terminal apparatus 1A.

In this way, since the user can acquire sales points by performing personal distribution, and receive a discount for purchasing songs, the user actively performs personal distribution among friends. For the distributor, the number of sales made through personal distribution by the user can be added to the number of contents sold directly to the user from the distribution server 2. Moreover, the user advertises the distribution of the songs.

In personal distribution, there is no need to send contents from the distribution server 2 and so there is no need to increase the processing capacity of the distribution server 2. Also, since it is possible to avoid a concentrated amount of orders, it is possible to more promptly distribute ordered contents. The amount of data for sending the payment-complete key K from the payment-management server 3 and for sending sales points from the distribution data management server 4 is relatively small compared with the amount of data of the contents, so the burden on the servers is small. Therefore, the distributor can expect an increase in sales with hardly any increase in investment in equipment such as servers.

(1-6) Embodiment 2 of the Electronic Distribution Method

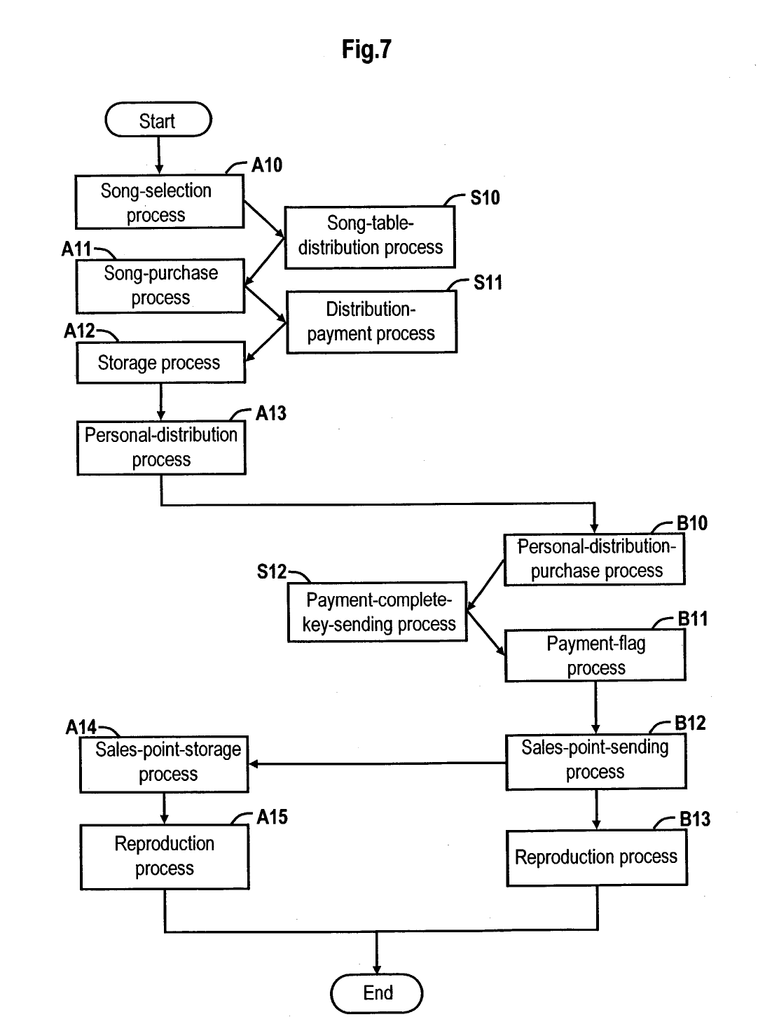

FIG. 7 is a flowchart of a second embodiment of the electronic distribution method of this invention, and shows the method for performing the function of the electronic distribution system explained using FIG. 2. This embodiment is for the same construction as shown in FIG. 2 where the distribution data management server 4 is omitted. There is a direct interface 26A installed in terminal apparatus 1A, and a direct interface 26B installed in terminal apparatus 1B. A cable can be used to connect between the direct interface 26A and direct interface 26B, and personal distribution from terminal apparatus 1A to terminal apparatus 1B is performed between direct interface 26A and direct interface 26B.

When performing personal distribution, the user A uses the display-control unit 24A to enter the song of the contents desired by user B, and, in the personal-distribution process (A13), the terminal apparatus 1A reads the contents corresponding to the song from the container in the memory unit 13A. Then the terminal apparatus 1A sets the payment flag in the container to ‘0’ and adds the ID of terminal apparatus 1A to the distribution log data 505 then outputs the contents to the direct interface 26A.

At terminal apparatus 1B, when the direct interface 26B receives the container, terminal apparatus 1B identifies the received contents and detects that the contents are the container, then stores it in the memory unit.

After user B receives the container, he/she performs a proof of purchase of the personally distributed contents using the same personal-distribution-purchasing process (B10) as in embodiment 1.

Next, the payment-management server 3, in the payment-complete-key-sending process (S12), reports the record of purchase for the ordered song as was done in embodiment 1, and performs the procedure for withdrawing the payment from the bank account of user B, then sends the payment-complete key K corresponding to the ordered song to terminal apparatus 1B. Since there is no distribution data management server 4, distribution data, for example, sales points, are not processed.

After terminal apparatus 1B receives the payment-complete key K from the payment-management server 3, in the payment-flag process (B11), or by another name, payment-data process, changes the payment flag from ‘0’ to ‘1’ to set the state allowing listening of the song. Also, the terminal apparatus 1B, in the sales-point-sending process (B12), outputs distribution data, for example, sales points from the direct interface 26B. The terminal apparatus 1B sends sales points after the payment-complete key K is received, so there is no improper operation such as receiving points even though there is no sales record.

After the terminal apparatus 1A receives the sales points that were sent from terminal apparatus 1B by way of the direct interface 26A, terminal apparatus 1A, in the sales-point-storage process (A14), or by another name, the distribution-data-storage process, detects that the received contents are sales points, and stores the received sales points. Storage is performed by adding the newly received sales points to the previously stored sales points.

Except for the processes explained above, the electronic distribution method of this embodiment is performed in the same was as that explained for embodiment 1.

Similar to the case of embodiment 1, with this method it is possible to expect an increase in sales due to personal distribution. Since distribution is not performed by way of an Internet service provider, there is no charge for the service of an Internet service provider. The distribution data management server 4 is also not necessary. In this case, user A and user B must bring terminal apparatus 1A and terminal apparatus 1B together to perform personal distribution so it is possible to simplify the system.

(1-7) Embodiment 3 of the Electronic Distribution Method

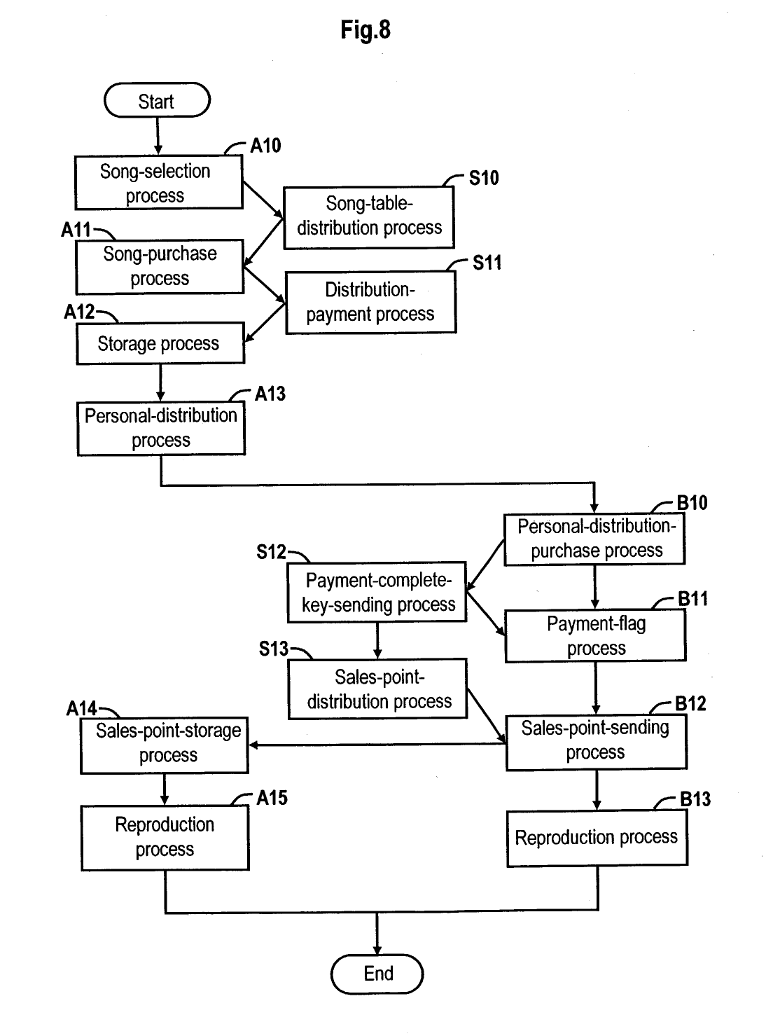

FIG. 8 is a flowchart showing a third embodiment of the electronic distribution method of this invention.

In FIG. 8 there is a distribution data management server 4, and the distribution data management server 4 issues distribution data, for example, sales points.

The distribution data management server 4, in the sales-point-distribution process (S13), sends sales points to the terminal apparatus 1B. Terminal apparatus 1B does not issue sales points itself, but, in the sales-point-sending process (B12), transfers the received sales points to terminal apparatus 1A. The rest of this method is the same as that shown in FIG. 7. With this method, the distribution data management server 4 can handle processing when there are changes in the conditions for issuing sales points.

(1-8) Distribution Log Data

FIG. 5(A) and FIG. 5(B) explain the additional Information. The additional-information area stores the distribution log data together with the payment flag. The ID of past users who purchased the contents, are stored in the distribution log data 505. In the case of terminal apparatus 1A, user A is the first user to which the distribution server 2 sent the container, so the control unit 25A of terminal apparatus 1A writes the ID of terminal apparatus 1A in the additional information of the contents stored in the contents memory unit 13A. The timing at which the ID is written is when the container is obtained, for example, or when the container is send to another terminal apparatus.

After this container is distributed to terminal apparatus 1B by personal distribution, terminal apparatus 1B adds the ID of terminal apparatus 1B to the additional-data area 504 of the distributed container. In this way, it is possible to know which user this container was distributed to or which terminal apparatus it was distributed by. Also, since the ID of the terminal apparatus is known, it is possible to perform communication with a terminal apparatus of a past personal distributor.

When terminal apparatus 1B sends the proof of purchase for the personal distribution to the payment-management server 3, it also sends the distribution log data, and the payment-management server 3 gives the received distribution log data to the distribution data management server 4, which manages the distribution log. In this way, it is possible to know which songs are most often distributed by personal distribution, and to know which users perform personal distribution often, or what their preferences in music are, and thus this information can be used in marketing. For example, the information can be used in a personal-distribution promotional campaign. The information can also be used in events such as awarding special sales points from the distributor to users that have transmitted contents using personal distribution a specified number of times or more.

Also, sales points can be sent to the terminal apparatuses included in the distribution log data, or in other words, to past personal distributor members. In this way, the number of sales points received increases the more personal distribution is performed, so personal distribution spreads even more. Sales points can be sent from the terminal apparatus 1B, or can be sent by the distributor from the distribution data management server 4.

It is also possible to create an address for the terminal apparatus of the other party based on the ID data, attach sales points to be awarded to a sales-point-sending form and send that sales-point-sending form. Since the number of sales points issued greatly increases as personal distribution becomes more popular, it becomes necessary to take into consideration measures such as gradually decreasing the value of the sales points, in order to avoid crashing the system. For example, by limiting awarding sales points to personal distributors up to only the past three generations, it is possible to prevent an explosive increase in the amount of sales points.

Moreover, by having the user B record his/her own personal information (age, sex, music preference, etc.) in the distribution log data-record area and sending it to the distributor, sales points can be sent to terminal apparatus 1B from the distribution data management server 4. By doing this, the distributor can use that information in marketing, and it is an effective way to obtain newer information than that obtained when the distributor made the distribution contract with the user B.

(1-9) Communication Between the Server and Terminal Apparatus

Communication between the distribution server, payment-management server 3 and distribution data management server 4 and terminal apparatus 1A and 1B can be performed by a method of using an Internet IP address to establish a communication line. In this method, IP addresses must be prepared for the terminal apparatuses of all of the users. Since each terminal apparatus has its own IP address, it is possible to perform personal distribution between terminal apparatuses without going through an Internet service provider, and thus there are no charges for use of the Internet service provider.

A method can be used by which a service contract with an Internet service provider is made for both terminal apparatuses 1A, 1B, and after connecting by way of a dial-up connection, communication is performed in the form of data transmission according to e-mail and Internet protocol, and a request is sent to the Internet service provider for communication with the distribution server 2, payment-management server 3 or distribution data management server 4.

The terminal apparatus stores the contents of data to be transmitted to each server, or in other words, its own ID, contents, payment-complete key, sales points, ID of the other party or other necessary data, in data according to protocol for e-mail and Internet transmission, then attaches the address of the distribution server 2, payment-management server 3 or distribution data management server 4 and sends the data contents to the Internet service provider. The Internet service provider then transfers the data contents to the distributors servers. An example of using this kind of method was explained for personal distribution in embodiment 1 of the electronic distribution system and apparatus.

The distributor itself can also receive a dial-up connection by telephone line from the terminal apparatuses 1A, 1B, and perform communication between each server and the terminal apparatuses 1A, 1B. It is also possible to incorporate the terminal apparatuses 1A, 1B in mobile telephones, and use an Internet service or e-mail service that supports a mobile telephone system to perform communication with the servers of the distributor. Moreover, it is possible to incorporate the terminal apparatus in a in a personal data assistant (PDA) and perform communication using a PDA service.

(1-10) Structure for Executing the Music Generation Method

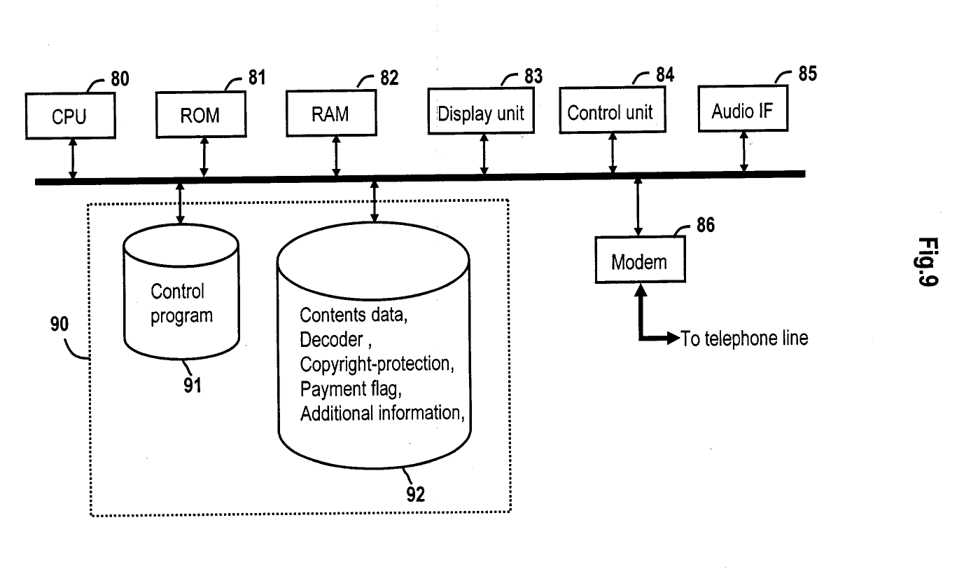

FIG. 9 is a drawing showing the computer system for performing the electronic distribution method of this invention. In FIG. 9, a CPU 80, ROM 81, RAM 82, display unit 83, control unit 84, audio IF 85, modem 86 and hard disc drive (HDD) 90 are connected to a bus line.

The control program 91 on the HDD 90 stores a program for the various control processes explained above. The container and sales points are stored in the memory area 92 of the HDD 90.

After the CPU 80 is started by the start-up program stored in ROM 81, the CPU 80 reads the program for each processing procedure from the control program 91 and executes each process as was explained above.

Part of the data and programs stored on the HDD 90 can be stored in ROM 81 or RAM 82.

(1-11) Another Embodiment of the Container

For this invention, distribution of a container that contains contents, which include the song contents and additional information related to the contents, and for which the status of the contents is ‘Paid’ or ‘Unpaid’, was explained. Here, another example of the container will be explained.

Here, a contents key is used that indicates the ‘Paid’ or ‘Unpaid’ status of the contents. In the contents-key method, an encoding process is performed on the contents when the contents are sent from the distribution server. These encoded contents can be decoded by the contents key. The user who receives the encoded contents purchases the contents key, and after decoding the encoded contents, can play the contents.

As the payment information, there is a storage area in the container for the contents key in which the contents key can be stored or removed. When there is a contents key in the storage area, the payment status is ‘Paid’, and when the contents key is removed, the payment status is ‘Unpaid’.

The additional information control units 18A, 18B remove the contents key from the container and performs personal distribution of containers with no contents key. The contents key is removed from the container in the personal-distribution process (A13).

The terminal apparatus 1B, by the purchase control, purchases the contents key from the payment-management server, receives the contents key, stores the contents key in the received container, and sets the status of the container to ‘Paid’. The contents-operation unit uses the contents key to decode the contents so the contents can be played. The contents key is sent from the payment-management server. In the payment-complete key-sending process (S12) the contents key is sent in the place of the payment-complete key. In the payment-flag process (B11) the received contents key is stored in the container. In the reproduction processes (A15), (B13), the contents key is used to decode the contents, after which the reproduction process is performed.

Furthermore, as another example, a method is possible in which there is no space prepared in the container for storing the payment data or contents key, and the contents key is attached or not attached outside of the container to distinguish between the ‘Paid’ status or ‘Unpaid’ status.

The distribution server 2 sends the container and contents key to the terminal apparatus 1A at the same time. Also, in the distribution-payment process (S11), the container and contents key are sent at the same time. At terminal apparatus 1A, during personal distribution, the additional information control unit 18A removes the contents key and sends only the container having ‘Unpaid’ status. Also, in the personal-distribution process (A13), processing is similarly performed and only the container having ‘Unpaid’ status is sent.

The terminal apparatus 1B, through the purchasing operation, purchases the contents key from the payment-management server, and stores the received contents key near the container in the contents memory unit 13B. The contents operation unit uses the contents key to decode the encoded contents so that the contents can be played. In the payment-flag process (B11), the contents key is received instead of updating the payment flag, and it is stored and saved near the container. In the reproduction processes (A15), (B13), the contents key is used to decode the contents, and then as was already explained, the reproduction process is performed. The payment-management server, in the payment-complete-flag-sending process (S12), sends the contents key in the place of the payment-complete key.

(2-1) Embodiment 4 of the Electronic Distribution System and Apparatus

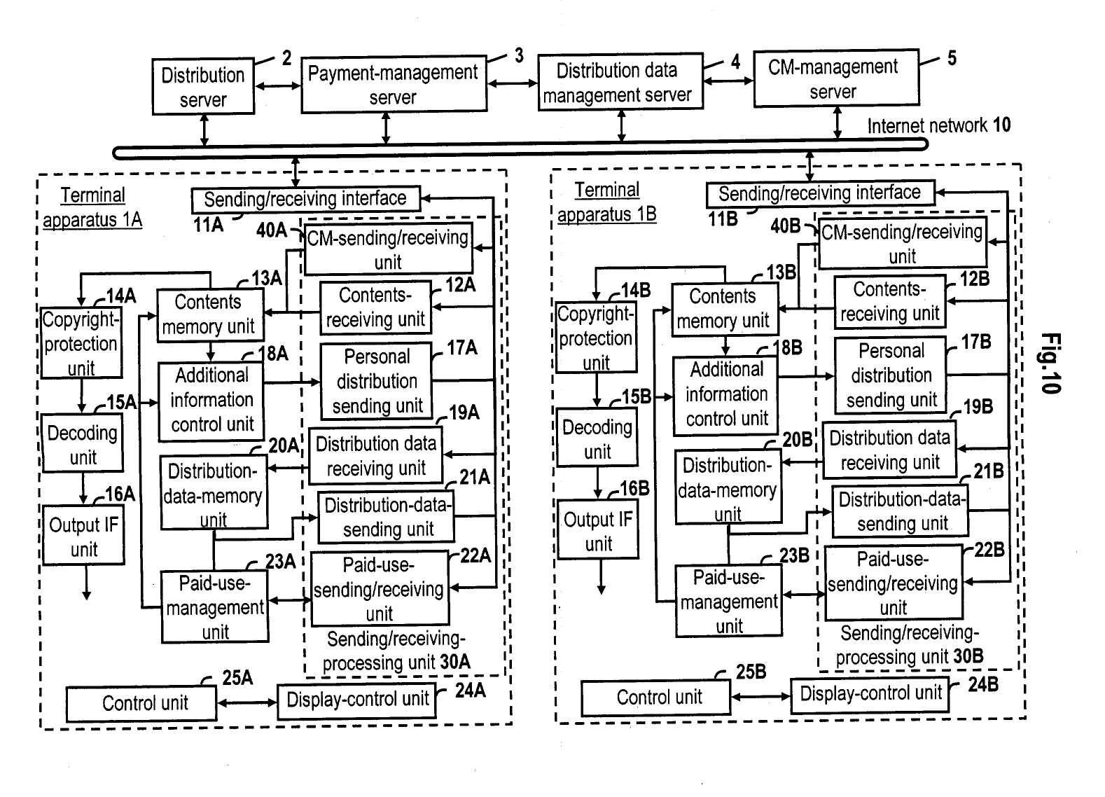

FIG. 10 is a block diagram of a fourth embodiment of the electronic distribution system of this invention. In FIG. 10, similar to embodiment 1, the electronic distribution system comprises: a distribution server 2, a payment-management server 3, a distribution data management server 4, Internet network 10, terminal apparatus 1A and terminal apparatus 1B, however, it also comprises a CM (Commercial Message) management server 5. The CM-management server 5 is a server that the distributor manages.

Also, the terminal apparatus shown in FIG. 10 has a CM-sending/receiving unit 40A that is added to the terminal apparatus 1A shown in FIG. 1. Similarly, terminal apparatus 1B also has a CM-sending/receiving unit 40B, and B is added to the reference numbers for the component elements in the place of A.

In the work of electronically distributing contents, in order to decrease the distribution fee paid by the user, CM is considered as a method for letting the user listen to the contents. CM adds a product name to the contents and sends it, and provides it to the user in audio and video before and while listening to the contents. The distributor can receive a CM fee, or so-called sponsor fee, from the business providing the CM, so makes it possible to reduce the cost to the user by that amount.

In this invention, through personal distribution, profits are passed on to the user performing personal distribution, and so promotes further expansion of personal distribution.

The CM-management server 5 attaches the commercial contents to the contents corresponding to the song. In this invention, the commercial contents will be referred to as CM contents.

In FIG. 10, the user A uses the display-control unit 24A of the terminal apparatus 1A to enter and order the desired song title M. The control unit 25A sends the song to the paid-use-management unit 23A and instructs that the order be made. The paid-use-management unit 23A adds the ID of terminal apparatus 1A and the address of the distribution server 2 to the song title M, and creates an order form, then sends the order form to the paid-use-sending/receiving unit 22A. The paid-use-sending/receiving unit creates data according to protocol for Internet transmission, and sends the data to the sending/receiving interface 11A. The sending/receiving interface 11A establishes a communication line with the distribution server 2, and sends the order form that contains the ID of terminal apparatus 1A and the song title M to the distribution server 2 via the Internet network 10.

The distribution server 2 confirms the ID of terminal apparatus 1A and the payment-management server 3 checks the contract with user A and checks whether it is possible to withdraw the payment from the bank account, for example. Here, when it is possible to withdraw the payment, the distribution server 2 puts the contents corresponding to the order song title M in a container and stores the copyright-protection information and payment information for song title M, as well as the CM contents that correspond to song title M, and sends it to terminal apparatus 1A via the established communication line.

The sending/receiving interface 11A receives the container, checks the received contents to make sure it is the container containing the contents, and gives it to the contents-receiving unit 12A. The contents-receiving unit 12A checks that the contents is the ordered song title, and stores the container with the contents in the contents memory unit 13A. The control unit 25A receives a report from the contents-receiving unit 12A that the ordered contents have been received, and sends an instruction to the paid-use-management unit 23A. According to that instruction, the paid-use-management unit 23A notifies the distribution server 2 by way of the paid-use-sending/receiving unit 22A and sending/receiving interface 11A that the ordered song title M was received properly.

The distribution server 2 receives the notification that the contents were received properly, and instructs the payment-management server 3 to withdraw payment from the bank account and to setting the account. The payment-management server 3 executes the settlement procedure according to the settlement decision.

Now the contents that are stored in the container are distributed. As described above, the container contains the contents, and essential additional information related to the contents, and it is possible to set the status of the contents to either ‘Paid’ or ‘Unpaid’. The CM contents can be included in the additional information in the container, or can be included in a separate container. In this invention, there are various ways in which the ‘Paid’ or ‘Unpaid’ status can be indicated. First, an example of storing the CM contents in the additional information and indicating the status using a payment flag will be explained.

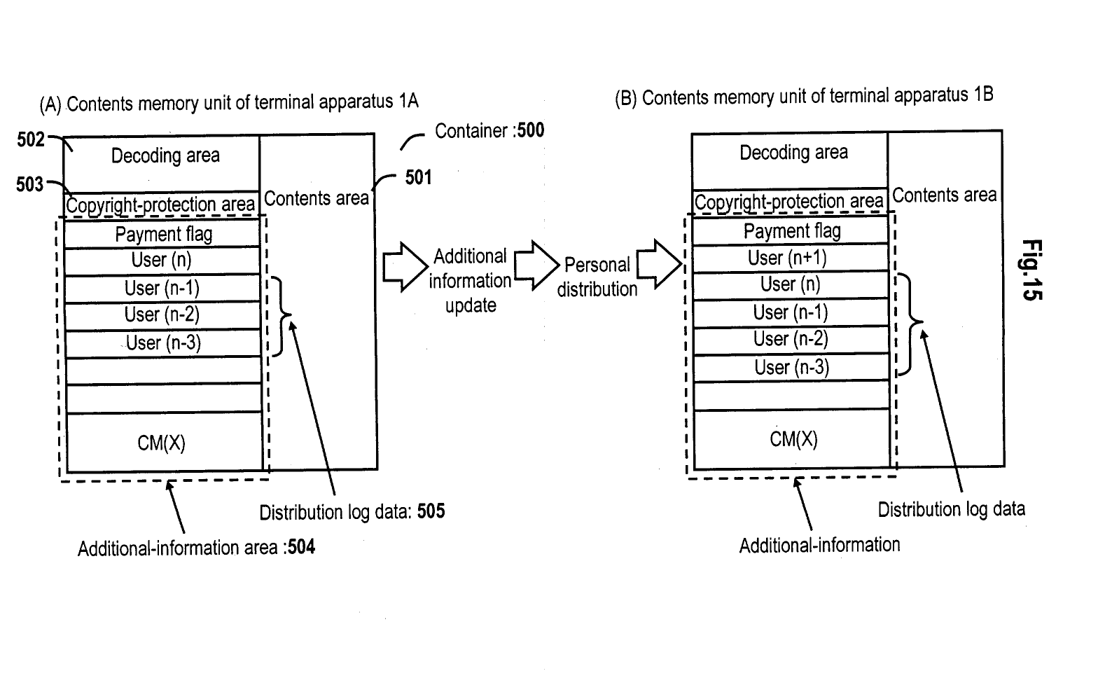

One example of the configuration of the container is shown in FIG. 15(A). In FIG. 15(A), the container comprises: a contents area 501 that stores the song data (contents), a decoding area 502 that stores a decoding program for decoding the compressed and encoded contents, a copyright-protection area 503 that stores information and data related to copyright protection of the contents, and an additional-information area 504.

Here, the contents are compressed data for a music signal, and the decoding program is software for decompressing and decoding that data. Also, information related to the copyright protection (copyright-protection information) is information related to the number of times the song title M has been ordered, the conditions for use such as how many time the song can be copied, copyright owner, and history of past copying of the song. Moreover, the additional information that is stored in the additional-information area, comprises: payment information that indicates whether or not the contents have been paid for, payment-flag format information, and distribution log data related to users who have used the contents. The payment flag can be ‘0’ for example to indicate ‘Unpaid’ status or ‘1’ to indicate ‘Paid’ status. In the case of these contents, since the payment process has already been performed, the distribution server 2 sets the payment flag and send it, and here the payment flag is set to ‘1’ to indicated that payment is complete. The status of the distribution log data area that stores the contents supplied from the distribution server 2 is ‘No record’ status. Also, the CM contents are stored in the CM(X) area in the additional-information area 504.

In order to listen to the contents corresponding to the ordered song title M, the user A uses the display-control unit 24A to give an instruction for the song to be played. Based on the instruction from the display-control unit 24A, the control unit 25A sends the contents from the contents memory unit 13A to the copyright-protection unit 14A, which performs the copyright-protection process based on the copyright-protection information. Since the payment flag of the contents received by terminal apparatus 1A is ‘1’, the copyright-protection process allows playing of the song. After playing of the song becomes allowed, the control unit 25A first reads the contents for song title M, and by way of the decoding unit 15A, decodes the contents and outputs the signal for song title M from the output IF unit 16A. The copyright-protection unit 14A and decoding unit 15A perform specific operation control, as described above, for the song and CM contents, and together they can be called the operation unit. By the processes described above, after the user A can enjoy playing the contents corresponding to song title M after listening to the CM.

Using the same processing as that of terminal apparatus 1B, user B can use terminal apparatus 1B to order and purchase the contents corresponding to song title M, and can enjoy listening to the music after or while listening to the CM.

In the electronic distribution system of this invention, contents can be distributed among a plurality of terminal apparatuses, for example, between terminal apparatus 1A and terminal apparatus 1B. In the case that user B listens to contents that were purchased by user A, and user B also wants to purchase those contents, it is possible for user A to distribute the purchased contents from terminal apparatus 1A to terminal apparatus 1B. This is called personal distribution. After user B performs the procedure for purchasing the contents distributed by user A, it is possible for user B to play the contents on his/her own terminal apparatus 1B.

Various methods can be used as the method for performing personal distribution, however one example of using an e-mail attachment file will be explained. User A uses the display-control unit 24A to enter the address of terminal apparatus 1B of user B and the name of the song title M of the contents desired by user 1B. The control unit 25A reads the container in the contents memory unit 13A and the additional information control unit 18A sets the payment flag to ‘0’. In other words the status of the container is set to ‘Unpaid’. Furthermore, the additional information control unit 18A adds the ID of terminal apparatus 1A to the distribution log data 505 in the container, and gives the container having ‘Unpaid status to a contents-sending unit having a function for sending the contents, or in other words, to the personal distribution sending unit 17A. The personal distribution sending unit 17A creates an e-mail for the address of terminal apparatus 1B, adds the container and requests the sending/receiving interface 11A to send the e-mail. The sending/receiving interface 11A uses a dial-up connection, for example, to call the contracted Internet service provider (not shown in the figure) and establish a communication line, and then requests that the e-mail be sent.

The personal distribution e-mail is temporarily stored by the Internet service provider. User B uses terminal apparatus 1B to make a dial-up connection with contracted Internet service provider of user B, and when terminal apparatus 1B executes a process for obtaining the e-mail, the e-mail is sent to terminal apparatus 1B. At terminal apparatus 1B, the sending/receiving apparatus 11B receives the e-mail, then detects that the attached file is a container and sends the container to the contents-receiving unit 12B. The contents-receiving unit 12B receives the container and stores it in the contents memory unit 13B.

After the user B receives the contents that were sent in the container, he/she uses the display-control unit 24B to enter proof of purchase for the personally distributed contents. The display-control unit 24B can have a control such as a purchase-confirmation button. The control unit 25B sends the song title M to the paid-use-management unit 23B and instructs that it perform an order for personal distribution. The paid-use-management unit 23B adds the ID of terminal apparatus 1B, the address of the payment-management server 3, and the ID of terminal apparatus 1A, which is the personal-distribution source, to the song title, and creates an order form for personal distribution, then sends the order form to the paid-use-sending/receiving unit 22B. The paid-use-sending/receiving unit 22B uses the form to create data according to protocol for Internet transmission and gives the data to the sending/receiving interface 11B. The sending/receiving interface 11B establishes a communication line with the payment-management server 3 and sends the order form containing the ID of terminal apparatus 1B and the song title M to the payment-management server 3 via the Internet network 10.

After receiving the order form, the payment-management server 3 check the ID of terminal apparatus 1B and sends a report of the record of payment for personal distribution of the ordered song title M to the distribution server 2. Also the payment-management server 3 perform the procedure for withdrawing the payment from the bank account of user B and returns a payment-complete key K for the ordered song M. Here, the payment-complete key K allows playing of the contents corresponding to the ordered song title M. It is preferred that this key only allows playing of the ordered song M.

Next, the payment-management server 3 sends the ID of terminal apparatus 1A, which is the personal-distribution source in this case, to the distribution data management server 4, and requests that contents-distribution data, for example, sales points be sent to terminal apparatus 1A. The distribution data management server 4 receives the request and sends sales points to terminal apparatus 1A.

After terminal apparatus 1B receives the payment-complete key K, the sending/receiving interface 11B check the received contents and detects that the payment-complete key K was received, gives the key to the paid-use-sending/receiving unit 22B. The paid-use-sending/receiving unit 22B then gives the received payment-complete key K to the paid-use-management unit 23B. The paid-use-management unit 23B uses the payment-complete key K to open the payment data, or in other words the payment flag, in the container stored in the contents memory unit 13B, and changes it from ‘0’ to ‘1’.

After the payment flag has been changed from ‘0’ to ‘1’, it becomes possible to play the contents corresponding to the song title M. When the user B uses the display-control unit 24B to give an instruction to start playing the ordered song M, the control unit 25B sends the copyright-protection information and payment flag from the contents memory unit 13B to the copyright-protection unit 14B, and the copyright-protection unit 14B performs the copyright-protection process. Since the payment flag is ‘1’, the copyright-protection unit 14B allows playing of the song in the copyright-protection process. The control unit 25B sends the CM contents and decoding software to the decoding unit 15B, and by way of the decoding unit 15B, decodes the CM contents and outputs the audio signal for the CM program from the output IF unit 16. Next, the control unit 25B sends the contents for song M, and by way of the decoding unit 15B, decodes the contents and outputs the music signal for song M from the output IF unit 16B. By the processes described above, the user B is able to enjoy playing the music after listening to the CM.

After terminal apparatus 1A receives the sales points that have been sent from the distribution data management server 4, the sending/receiving interface 11A of terminal apparatus 1A checks the contents. Since the received contents are sales points, the sending/receiving interface 11A gives the contents to the distribution data receiving unit 19A. The distribution data receiving unit 19A stores the received sales points in the distribution-data-memory unit 20A. Storage of the points is such that the newly received sales points are added to the previously stored sales points.

The contents-distribution data, or in other words, the sales points are used by the user when ordering a new song in order to receive a discount in the sales price. In order to send or receive sales points, a point form for storing the sales points is created, and that point form can be sent or received. The point form can be such that it stores one point or a plurality of points.

The user B of terminal apparatus 1B uses terminal apparatus 1B can also further personally distribute the contents corresponding to the song title M that was obtained through personal distribution from user A to the terminal apparatus IC of another friend C and acquire sales points. It is also possible for terminal apparatus 1A to personally distribute contents obtained through personal distribution for another terminal apparatus to yet another terminal apparatus.

In this way, CM contents are added to the contents for the song title M and distributed and the CM program is played for playing the song M, so the distributor can expect income from the sponsor fee from the sponsor for distributing the CM.

It is also possible for the distribution data management server 4 to issue sales points, and send them to terminal apparatus 1A by way of terminal apparatus 1B. In this case, the sending/receiving interface 11B detects that the payment-complete key K and sales points are received and send the received sales points to the distribution data receiving unit 19B. The control unit 25B temporarily stores the received sales points in the distribution-data-memory unit 20B, and instructs the distribution-data-sending unit 21B to create and send an e-mail addressed to terminal apparatus 1A. The distribution-data-sending unit 21B attaches the sales points to the e-mail addressed to terminal apparatus 1A and gives the e-mail to the sending/receiving interface 11B. The sending/receiving interface 11B starts the e-mail software, establishes a communication line with the Internet service provider, and sends the e-mail. The Internet service provider sends the received e-mail to terminal apparatus 1A.

It is also possible for terminal apparatus 1B to issue sales points and send them to terminal apparatus 1A. In this case, after receiving the payment-complete key K, at terminal apparatus 1B, the paid-use-management unit 23B issues sales points according to an instruction from the control unit 25B, and sends them to the distribution-data-sending unit 21B. The distribution-data-sending unit 23B creates an e-mail addressed to terminal apparatus 1A, which is the personal-distribution source, attaches the sales points and gives the e-mail to the sending/receiving interface 11B. The sending/receiving interface 11B starts the e-mail software, establishes a communication line with the Internet service provider, and sends the e-mail. The Internet service provider sends the received e-mail to terminal apparatus 1A.

(2-2) Embodiment 5 of the Electronic Distribution System and Apparatus

In embodiment 4, sales points were issued for personal distribution and given to the sender, user A. In this embodiment, sales points are awarded to user A when user B listens to the CM. The number of sales points issued can be the same number or a fixed percentage of the sales points awarded for personal distribution and is set according to the plans of the distributor.

Sales points for listening to the CM are also issued when issuing sales points for personal distribution, and the total number of sales points are sent. As in embodiment 4, the route for issuing and sending sales points can be: 1) a route in which the distribution data management server 4 issues the points and sends them to terminal apparatus 1A, 2) a route in which the distribution data management server 4 issues the points and sends them to terminal apparatus 1B, and then terminal apparatus 1B sends the points to terminal apparatus 1A, or 3) a route in which terminal apparatus B issues the points and sends them to terminal apparatus 1A.

Also, sales points for listening to the CM can be awarded to user B for listening. As in embodiment 4, the route for issuing and sending sales points can be: 1) a route in which the distribution data management server 4 issues the points and sends them to terminal apparatus 1B, or 2) a route in which inside terminal apparatus 1B, the paid-use-management unit 23B issues the points according to an instruction from the control unit 25B and stores the points in the distribution-data-memory unit 20B.

(2-3) Embodiment 6 of the Electronic Distribution System and Apparatus

In embodiment 5, sales points for listening to the CM were issued and awarded to the sender, user A, and listener, user B, when user B listened to the CM. In this embodiment, when user B listens to the CM, CM distribution data, or in other words, CM points are issued in the place of sales points, and awarded to user A. The number of CM points issues are set separately from the number of sales points awarded for personal distribution, and are set according to the business plan of the distributor.

CM points for listening to the CM are also issued when issuing sales point for personal distribution. As in embodiment 4, the route for issuing and sending CM points can be: 1) a route in which the distribution data management server 4 issues the points and sends them to terminal apparatus 1A, 2) a route in which the distribution data management server 4 issues the points and sends them to terminal apparatus 1B, and then terminal apparatus 1B sends the points to terminal apparatus 1A, or 3) a route in which terminal apparatus B issues the points and sends them to terminal apparatus 1A. At terminal apparatus 1A, which receives the CM points by way of the sending/receiving interface 11A and distribution data receiving unit 19A, the control unit 25A, for example, obtains the CM points, and adds them to the sales points in the distribution-data-memory unit 20A. The ratio of CM points that are added with respect to sales points, is decided in advance by the distributor, and that ratio is used.

CM points for listening to the CM can also be awarded to user B, who listened to the CM. As in embodiment 4, the route for issuing and sending sales points can be: 1) a route in which the distribution data management server 4 issues the points and sends them to terminal apparatus 1B, or 2) a route in which inside terminal apparatus 1B, the paid-use-management unit 23B issues the points according to an instruction from the control unit 25B and stores the points in the distribution-data-memory unit 20B.

(2-4) Embodiment 7 of the Electronic Distribution System and Apparatus

In embodiment 7, CM points are stored in a memory unit other than the distribution-data-memory unit 20A, and the sales points and CM point are handled separately.

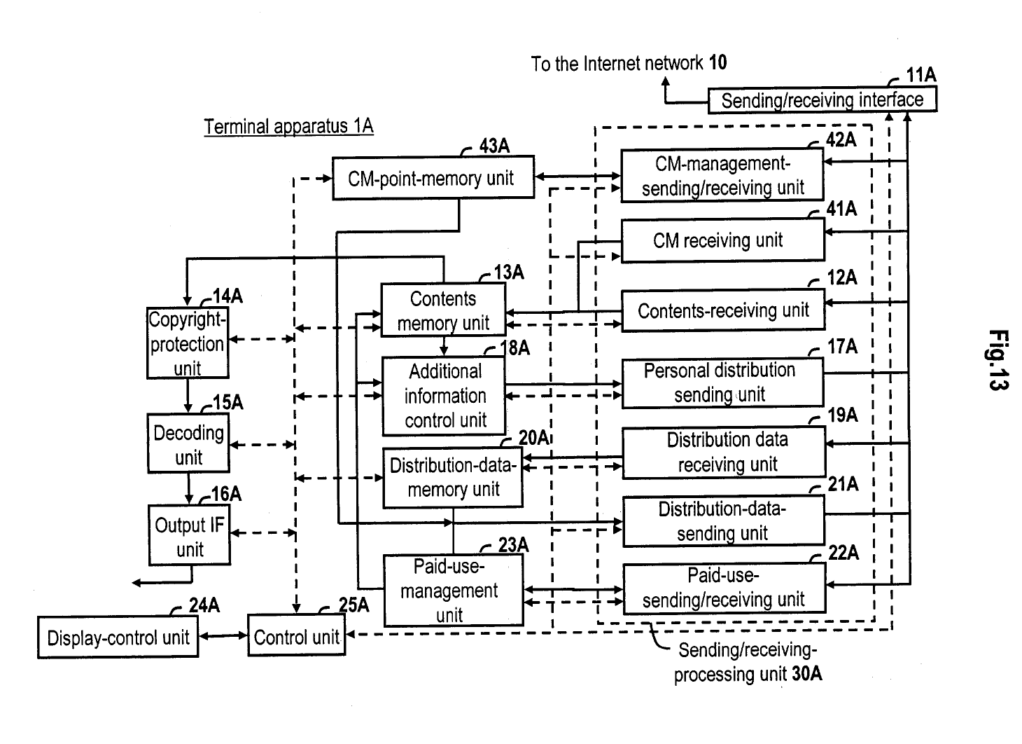

FIG. 13 is a drawing showing the construction of the terminal apparatus 1A used in embodiment 7. This explanation will center on the points that differ from those of embodiment 4 that were explained using FIG. 10. In this embodiment, instead of the CM-sending/receiving unit 40A of the terminal apparatus 1A shown in FIG. 10, there is a CM-receiving unit 41A, CM-management-sending/receiving unit 42A and CM-point-memory unit 43A. The construction of terminal apparatus 1B is the same. The CM-point-memory unit 43A is a memory for storing CM-distribution data, so it can also be called the CM-distribution-data-memory unit.

In the case that terminal apparatus 1A performs personal distribution, the control unit 25A sends a command to the CM-management-sending/receiving unit 42A to create a CM-request form, which contains the ID of terminal apparatus 1A and the song title M, send that form to CM-management server 5, and receive a CM list corresponding to the song title M. The CM-management-sending/receiving unit 42A gives the received CM list to the control unit 25A, and the control unit 25A displays the CM list on the display-control unit 24A. User A selects one or more CMs from the CM list by way of the display-control unit 24A. The control unit 25A gives the name or ID of the selected CM to the CM-management-sending/receiving unit 42A, and the CM-management-sending/receiving unit 42A sends that data to the CM-management server 5 by way of the sending/receiving interface 11A. The CM-management server 5 then send the selected CM contents to terminal apparatus 1A.

The sending/receiving interface 11A detects that the received contents are CM contents and gives them to the CM-receiving unit 41A. The CM-receiving unit 41A stores the CM contents in the CM storage area in the additional-data area in the contents memory unit 13A. The additional-data-control unit 18A sets the payment flag to ‘0’, and the personal distribution sending unit 17A performs personal distribution. By changing the CM contents in this way when performing personal distribution, it is possible to provide the most recent CMs, and prevent providing old, out-of-date CMs.

In the explanation above, user A selected the CM contents, however, it is also possible for the CM-management server 5 to automatically select the CM contents for song title M based on set rules, or for terminal apparatus 1A to automatically select the CM contents based on set rules. The rule could be to progressively change the CM contents in the order of the CM list, or to select the CM contents at random. Also, it is possible to set a ratio or probability for the number of times CM contents are selected according to the sponsor fee that is paid for the CM contents. This kind of embodiment will be explained below.

When user B desires to purchase the contents that were personally distributed to and received by terminal apparatus 1B, he/she presses the purchase button, for example, on the control section of the display-control unit 24B of terminal apparatus 1B and performs the proof of purchase process for purchasing song M. User B obtains the payment-complete by the same procedure as in embodiment 4.

In the case that terminal apparatus 1B issues and sends CM points, the control unit 25B of terminal apparatus 1B instructs the CM-management-sending/receiving unit 42B to send CM points to terminal apparatus 1A.

At terminal apparatus 1A, the sending/receiving apparatus 11A receives the CM points and gives them to the CM-management-sending/receiving unit 42A, and the CM-management-sending/receiving unit 42A stores the received CM points in the CM-point-memory unit 43A. This same operation is performed when CM points are sent from the distribution data management server 4.

When purchasing the next song (contents), the acquired CM points are added to the sales points in the distribution-data-memory-unit 20A and entered in the point column of the order form and sent to the distribution server 2 from the paid-use-sending/receiving unit 22A, and a discount can be received. The amount of CM points used is subtracted from the CM-point-memory unit 43A. It is also possible to send CM point separately from sales points, and as will be described later, the distributor can use them in calculating the sponsor fee.

In this embodiment, an example of terminal apparatus 1A personally distributing the container after the CM contents were updated was explained. Next another embodiment of updating the CM contents will be explained.

When terminal apparatus 1A performs personal distribution, the additional information control unit 18A removes the CM contents from the additional data, and sends a container with no CM contents from the personal distribution sending unit 17A to terminal apparatus 1B. Terminal apparatus 1B performs the payment process with the payment-management server 3, and at the same time that the payment-management server 3 sends a notification that payment is complete, new CM contents are distributed from the CM-management server 5. Terminal apparatus 1B receives the payment-complete notification and the CM contents and stores the received CM contents in the container in the contents memory unit 13B and updates the payment flag. When terminal apparatus 1B plays the contents corresponding to song title M, it also plays the CM contents.

As was previously explained, for the CM contents received by terminal apparatus 1B, it is possible for the CM-management server 5, terminal apparatus 1B or user B to select contents from a CM list of a plurality of CM contents that correspond to the song title M.

Next, yet another embodiment of updating the CM contents by terminal apparatus 1B will be explained. As mentioned above, the container used in this invention is such that it contains the contents and additional information related to the contents, and can take either ‘Paid’ status or ‘Unpaid’ status, and the CM contents can be contained in the additional information or can be contained in a separate container. In this kind of container, the CM contents are stored in a separate container without being stored in the additional information. When terminal apparatus 1A personally distributes the contents corresponding to song title M, the additional-data-control unit 18A removes the separate container, and the personal distribution sending unit 17A does not send CM contents.

On the other hand, after receiving the personally distributed contents, terminal apparatus 1B performs the procedure for purchasing the song title M. At the same time the payment-management server 3 sends a notification that payment is complete, the CM-management server 5 stores new CM contents in a separate container and sends the container. After terminal apparatus 1B receives the payment-complete notification and the container in which the CM contents are stored, the CM-receiving unit 41B stores the received separate container in the contents memory unit 13B, and the paid-use-sending/receiving unit 22B, by way of the paid-use-management unit 23B updates the payment flag for the container in the contents memory unit 13. As was already explained, the terminal apparatus 1B plays the CM contents when playing the song M.

Also, distribution of CM contents to terminal apparatus 1 can be performed when playing song M. When an instruction to play the song M is given from the control section, the control unit 25B sends a request to the CM-management-sending/receiving unit 42B to notify the CM-management server 5 of the ID of song title M and request that the CM contents be sent. The CM-management server 5 stores the CM contents corresponding to song title M in a separate container and sends the container to terminal apparatus 1B. The received contents are stored in the contents memory unit 13B by the same operation as already explained. When playing the contents it is necessary to establish a communication line between terminal apparatus 1B and the CM-management server 5, however, there is the advantage that the latest CM contents can be provided. Also, the user B can listen to different CMs each time.

(3-1) Embodiment 8 of the Electronic Distribution System and Apparatus

In embodiment 4, the CM attached to the song M was one type that was decided on by the distributor. In embodiment 7, an example of selecting and attaching a CM from a plurality of CMs that were prepared for song M was explained. Here, a process for the CM-management server 5 to select the CM will be explained in more detail.

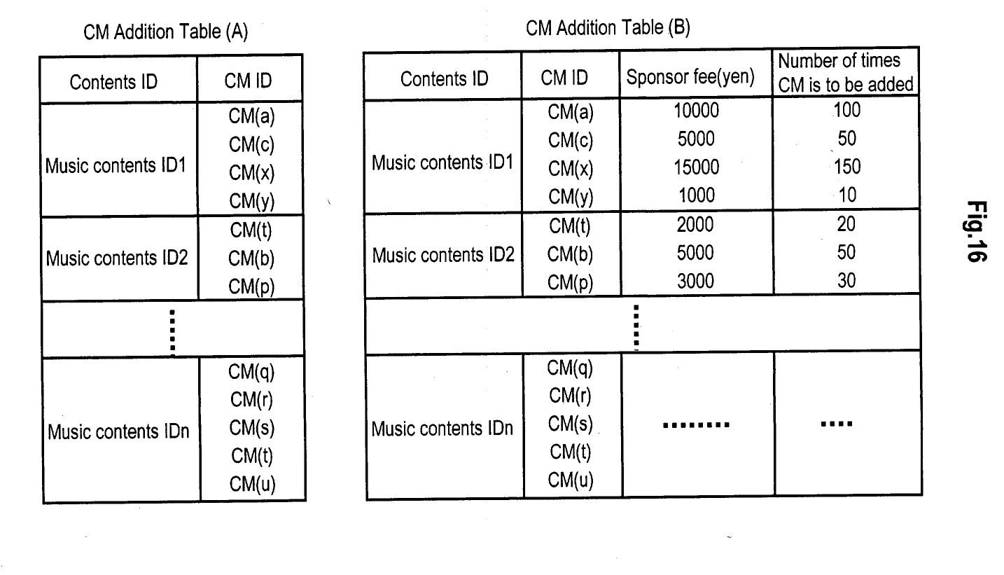

In this embodiment, as shown in FIG. 16, the CM-management server 5 has a CM table (A) of the CM contents that are provided when each time a song is distributed. When there distribution server 2 or terminal apparatus requests CM contents, the CM-management server 5 selects and provides CM contents from a plurality of CM contents that correspond to the ID of the indicated song. For example, CM contents are selected and provided from the contents CM(a), CM(c), CM(x) and CM(y) for the song having music contents ID 1. Similarly, CM contents are selected and provided from the contents CM(t), CM(b) and CM(p) for the song having music contents ID 2. CMs are prepared that can be provided for all music contents. Selection of the CM is performed by the CM-management server 5 according to set rules. Typically, the rules are decided by the CM sponsor and distributor. A rule such as deciding the selection rate according to the sponsor fee is possible.

When the terminal apparatus 1A sends an order to the distribution server 2 to distribute the contents of a desired song title M, the distribution server 2 gives the song title M to the CM-management server 5, and the CM-management server 5 selects one CM from a plurality of CM contents that correspond to the song title M and gives the contents to the distribution server 2. The distribution server 2 stores the CM contents in the CM storage area in the additional-information area, places it in a container together with the music contents, decoding software and copyright-protection data, and sends the container to terminal apparatus 1A.

When user A personally distributes contents corresponding to song title M to user B, in addition to performing the operation of embodiment 4, the control unit 25A of terminal apparatus 1A sends an instruction to the CM-sending/receiving unit 40A to create a CM-request form that contains the ID of terminal apparatus 1A and the song title M, and to send the request form to the CM-management server 5 via the sending/receiving interface 11A. The CM-management server 5 sends the CM contents corresponding to song title M to terminal apparatus 1A. The CM-sending/receiving unit 40A receives the CM contents via the sending/receiving interface 11A and stores the CM contents in the CM storage area in the container in contents memory unit 13A. Then, using the same procedure as in embodiment 4, terminal apparatus 1A personally distributes all of the contents to terminal apparatus 1B. In the case that the CM-management server 5 automatically selects the CM, it is possible for terminal apparatus 1A not to select the user CM. Also, it is possible for terminal apparatus 1A to select the CM automatically from a CM list according to set rules.

After proof of purchase is performed using terminal apparatus 1B, the CM is played before playing the personally distributed song.

Since the CM contents are changed when performing personal distribution in this way, it is possible to provide the latest CMs and prevent providing old, out-of-date CMs.

Through negotiations between the copyright owner of the music and the provider of the CM, it is possible to prepare the most suitable CM contents for the song in advance.

It is possible to attach a plurality of CM contents to the song title M. It is also possible for the control unit 25A to check the number of attached CM contents and to send CM points for that number.

(3-2) Embodiment 9 of the Electronic Distribution System and Apparatus (CM Attachment Condition)

The CM Addition Table (B) shown in FIG. 16 is another example. In this embodiment, the number of times a CM is added is determined in advance according to the CM contents. In the CM Addition Table (B) shown in FIG. 16, CM(a) is added for 100 distributions. The number of times other CM contents are added is also determined. The sponsor fee for adding the CM one time is, for example, 100 yen.

(3-3) Embodiment 10 of the Electronic Distribution System and Apparatus (CM Addition Condition)

Another factor for determining the sponsor fee is whether or not the song becomes a hit. Since many people will purchase a hit song, more advertisement effect can be expected, so the sponsor fee is set high. For a song by an unknown artist, the sponsor fee is set low. From the position of the owner to the rights of the music contents, in the case of an unknown artist, expenses for distributing the music can be covered by obtaining sponsors even though the sponsor fee is low, so it is possible for the music contents to become popular and spread quickly and cheaply. By increasing the number of sales points and CM points, increased popularity through personal distribution can be expected. Moreover, by changing the number of sales points and CM points issued according to the song (contents), this embodiment can be used for promoting sales.

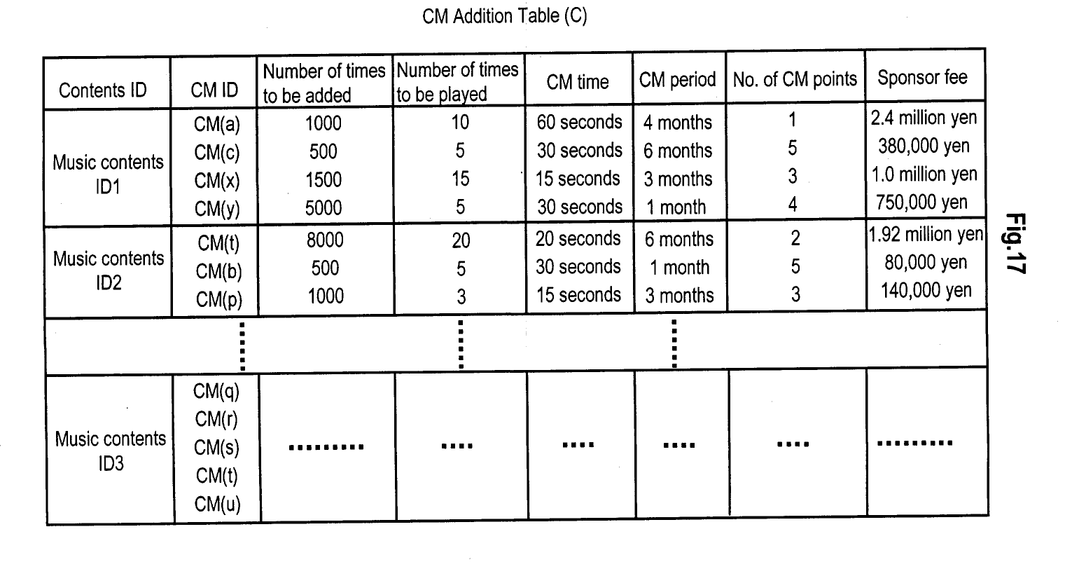

FIG. 17 is an example of the case of adding various CMs based on addition conditions as described above. The CM Addition Table (C) shown in FIG. 17 shows contents that can be added to each song and the conditions for adding those CM contents. The number of times a CM can be added is the total number of times the CM is distributed.

For example, for CM(a), the CM contents are added up until the 1000th time music contents ID1 is ordered, and not added after that. The number of times played is number of times the CM contents are played by the terminal apparatus that received the contents. CM(a) is played before playing the music contents ID1, and after the 11th time, the CM contents are no longer played. The CM time is the length of time it takes to play the CM. The CM period is the period the CM is played, for example, in the case that the period is 4 months, then the 5th month after distribution, the CM will not be played. The number of CM points is the number of CM points, or by another name, the number of CM-distribution data awarded for personally distributing the CM or for listening to the CM. The more times the CM is added, the more times the CM is played, the longer the CM time or the CM period is, or the more number of CM points awarded, the higher the CM effect is, so the sponsor fee can be higher.

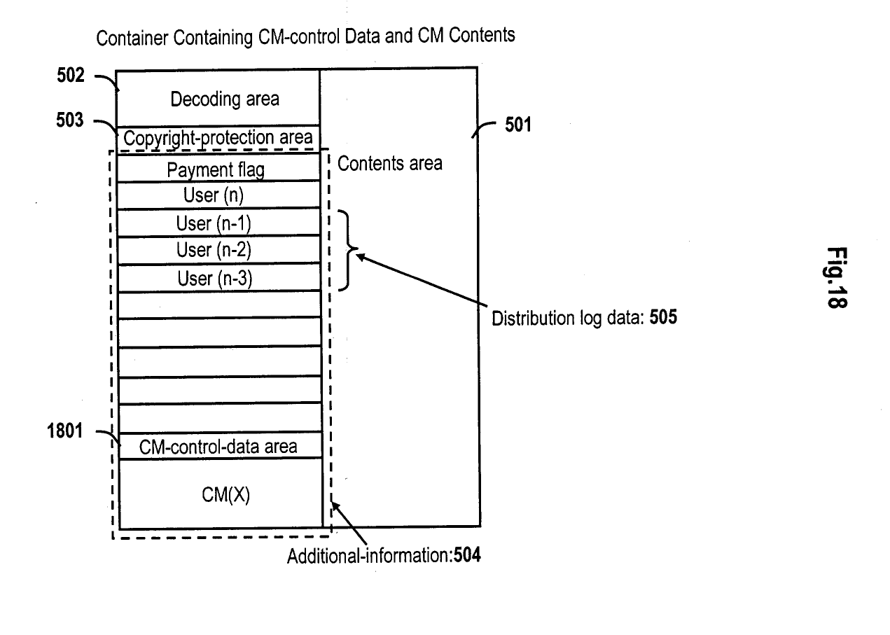

The CM management server 5 has a table indicating the information of this kind of CM addition table, and it references the table when sending CM contents. When an order for music contents ID1 is received from terminal apparatus 1A, the CM-management server 5 selects a CM from among CM(a), CM(c), CM(x) and CM(y) and stores it in a container. When storing the CM contents, it stores data for the CM-ID, number of times to be played, CM time, CM period and number of CM points in the CM-control-data-area 1801 in the container as shown in FIG. 18, and sends the container. The total number of times a CM is added is calculated and stored in memory, and when a CM is added the number of times is increased by 1.

In the case that the CM contents are updated when terminal apparatus 1A performs personal distribution to terminal apparatus 1B, the CM-management server 5 performs the same process as in the first distribution, for the request to update the CM contents from terminal apparatus 1A. The CM-management server 5 calculates the total number of times each CM has been added, and stores it memory, and increases the number of times by 1.

In the explanation above, the total number of times a CM was distributed was limited, however, having no limits is also possible. In FIG. 17, the column for the number of times a CM is added is the addition percentage, and in the case of music contents ID1, four CM addition percentages are set. For example, for CM(a), CM(b), CM(x) and CM(y), they are 12.5%, 6.25%, 18.75% and 62.5%, respectively, and the CMs are attached according to these percentages when distributing music contents ID1. The CM-management server 5 calculates the total number of times that each CM has been distributed and stores it in memory, and the sponsor pays a sponsor fee for the times a CM has been distributed. The sponsor fee per one distribution is not limited to the same fee, and can be changed according to the number of times the CM is played, the CM time, the CM period and the number of CM points.

In personal distribution, when a method is used of updating the CM each time a terminal apparatus performs personal distribution, the CM-management server 5 can know how many times a CM is distributed, so the number of times the CM is distributed by personal distribution can also be added. In personal distribution, when continuing to distribute the CM that is already stored in the container, the CM-ID of the stored CM is sent when the terminal apparatus 1B that received the personal distribution purchases the contents. In this way, the distribution data management server 4 knows that the CM has been distributed and adds 1 to the total number of times the CM has been distributed and stores it in memory.

In the explanation above, the number of times a CM is played was set by the distributor according to data about the number of times the CM was played. In a different system, it is possible for user B to use terminal apparatus 1B to select the number of times a CM is played. Using the control section of terminal apparatus 1B, user B enters the number of times to play the distributed CM. The number of times the CM is played is called the user's desired CM play frequency data. A plurality of play modes can be prepared and the number of times a CM to be selected in the future is played can be selected. When terminal apparatus 1B pays for the personal distribution, the CM-ID and user's desired CM play frequency data are sent to the CM-management server 5.

The larger the user's desired CM play frequency data is, the higher the sponsor fee is. In the case of paying the sponsor fee according to the user's desired CM play frequency data, the sponsor pays the fee after distribution.

The user's desired CM play frequency data is also sent to the distribution data management server 4, and the distribution-data-management 4 issues CM points to the number of set according to the user's desired CM play frequency data and sends the CM points to terminal apparatus 1A, which is the personal-distribution source. It is also possible for the terminal apparatus 1B itself to issue CM points and send them to terminal apparatus 1A. The number of CM points issued can be set just for the user's desired CM play frequency data, or can be set based on set rules that include data such as the number of times a CM is added, number of times a CM is played, CM time, CM period and number of CM points in the CM Addition Table (C) shown in FIG. 17 or the stored in the CM-control-data area. When the user's desired CM play frequency data is ‘0’, or in other words, when the CM is not played, it is possible to increase the price of the contents paid by user B.

When the CM points are sent the next time music contents are purchased, and the price of the music contents is discounted. The number of CM points is and index of the effectiveness of the CM. By issuing, sending and storing the CM-ID for the CM when issuing CM points, and attaching the CM-ID and CM points as a set when the contents are purchased, it is possible for the distributor, in the payment process, to know from the CM-ID and number of CM points how many times each CM is listened to. The source of revenue for the price discount can be collected from the sponsor in proportion to the number of times the CM is listened to. In this case, it is preferred that a set number of CM points, for example one point, be issued for each time the CM is listened to. Also, data for the number of times a CM is played and the number of CM points awarded do not have to be used as CM control data.

(4-1) CM Play Modes and Rules for Issuing CM Points

Various CM play modes and rules for issuing CM points are possible. First, a method using CM Addition Table (C) shown in FIG. 1 will be explained.

When the terminal apparatus 1A receives the container, it reads the CM-ID for the CM-control data, number of times the CM is to be played, the CM time, and CM period data and stores them in the control unit 25A. When user A instructs terminal apparatus 1A to play the contents, the control unit 25A checks the saved data for the number of times the CM is to be played. First, the number of times the CM is to be played is not ‘0’, so the control unit 25A plays the CM contents, and after that plays the music after performing the copyright-protection process and decoding process for the music contents as already explained. Also, the number of times the CM is to be played that was copied in the control unit 25A is decreased by ‘1’ time. The CM time can be displayed on the display-control unit 24A in order to inform the user A. The control unit 25A compares the CM period data with the current year, month and date data stored in the terminal apparatus 1A, and when the CM period has expired, the music contents will be played without playing the CM.

At terminal apparatus 1B that receives personally distributed contents, after terminal apparatus 1B performs the payment process, the it performs the operation for playing the music contents in the same was as terminal apparatus 1A, and plays the CM based on the attached CM-control data. In the case that terminal apparatus 1B issues CM points, it sends CM points to terminal apparatus 1A according to CM-point data.

In the case that the distribution data management server 4 issues CM points, during the payment process, terminal apparatus 1B sends the ID of terminal apparatus 1A and the CM-ID to the distribution data management server 4 by way of the payment-management server 3, and requests that CM points be issued. The distribution-management server 4 references the CM Addition Table, checks the number of CM points, issues the CM points and sends them to terminal apparatus 1A.

(4-2) Another Example of CM Playing Modes and Rules for Issuing CM Points

It is also possible for the user to use the terminal apparatus to select the play mode such as how many times the CM will be played, and to change the number of CM points issued and awarded according to the play mode and number of times the CM is played.

Some possible play modes for the CM are: 1) playing the CM only one time when playing the song M for the first time; 2) playing the CM every time the song M is played; 3) selecting the number of times the CM is played; and 4) playing just the CM several times intensively. The number of CM points to issue for each of these play modes is then decided.

The CM play mode or number of times the CM is to be played is entered from the control unit of the terminal apparatus 1B. The number of times the CM is played is called the user's desired CM play frequency data. When terminal apparatus 1B performs the process of paying for personal distribution, it informs the CM-management server 5 of the ID of terminal apparatus 1A, which is the personal-distribution source, the CM-ID and the user's desired CM play frequency data. The CM-management server 5 informs the distribution data management server 4 of the ID of terminal apparatus 1A and the desired CM play frequency data, and the distribution data management server 4 sends just a set number of CM points to terminal apparatus 1A. In a method where terminal apparatus 1B itself issues CM points, terminal apparatus 1B issues the specified number of CM points and sends them to terminal apparatus 1A.

Even when terminal apparatus 1A first purchases the contents corresponding to song title M, it is possible to have the user A select the CM play mode using terminal apparatus 1A. It is also possible to have CM points issued internally by terminal apparatus 1A according to the selection. It is also possible to have terminal apparatus 1A notify the CM-management server 5 of the play-mode selection, and to have the CM points sent from the distribution data management server 4.

Moreover, CM points can also be awarded each time the CM is played. In this case, when the user B plays the contents the correspond to song M on terminal apparatus 1B, the control unit 25B issues CM points, and sends the points from the CM-management-sending/receiving unit 42B to terminal apparatus 1A. It is also possible to not send the CM point each time the contents are played, but to save the issued CM points and when a set number of CM points have been saved, to send them together to terminal apparatus 1A.

The more times the user plays the CM, the higher the sponsor fee can be. The sponsor pays a base sponsor fee, and then pays a metered sponsor fee according to the record of how many times the CM is played. In order to do this, the distributor collects the CM-ID and the record data of the number of times the CM has been played by way of the CM management server 5 and the distribution data management server 4, and keeps totals of the number of times each CM has been played, and sends a bill to each sponsor for the sponsor fee for the number of times the CM is played each month, for example.

It is also possible to have terminal apparatus 1B notify the distribution data management server 4 of the record data for the number of times the CM has been played. The distribution data management server 4 then issues a determined number of CM points according to the record data for the number of times the CM has been played, and sends the CM points to terminal apparatus 1A, which is the personal distribution source. As described above, it is also possible for terminal apparatus 1B to issue the CM points itself and send them to terminal apparatus 1A. The number of CM points issued can be determined according to just the record data of how many times the user plays the CM, or can be determined based on set rules which include data such as the number of times data are added to the CM-control-data area, the number of times the CM is to be played, the CM time, CM period and number of CM points.

When CM points are sent the next time music contents are purchased, the purchase price of the music contents is discounted. The number of CM points is an index indicating the effectiveness of the CM. By issuing, sending and storing the CM-ID for the CM when issuing the CM points, and then attaching the CM-ID and CM points as a set when the contents are purchased, it is possible for the distributor, in the payment process, to know from the CM-ID and number of CM points the number of times each CM has been listened to. The source of revenue for the price discount can be collected from the sponsor in proportion to the number of times the CM is listened to. In this case, a fixed number of CM points, for example 1 point, can be issued each time the CM is listened to. Also, data in CM Addition Table (C) in FIG. 17 for the number of times the CM is to be listened to and the number of CM points, do not have to be handled as CM-control data.

When using acquired and stored sales points or CM points, the user can display the number of points on the display-control unit 24A, and enter the number of points to use and change the number of points used in the order of a song.

There is also a method of selecting the CM play mode when performing proof of purchase of the song M, and having it reflected in the sales price for song M. In this case, CM play mode data it attached and sent when terminal apparatus 1B performs proof of purchase, and the payment-management server 3 applies the discount determined according to the received CM play mode data for the payment.

When the user's desired CM play frequency data is ‘0’, or in other words, when the CM is not to be played, the amount paid by user B can be increased.

Moreover, it is also possible to divide up the CM points between terminal apparatus 1A and terminal apparatus 1B. For example,

⅓ of the CM points issued are sent to terminal apparatus 1A, and ⅔ of the CM points are acquired by terminal apparatus 1B. The acquired ⅔ of the CM points are saved in the CM-point-memory unit 43B.

(5-1) Embodiment of the Terminal Apparatus

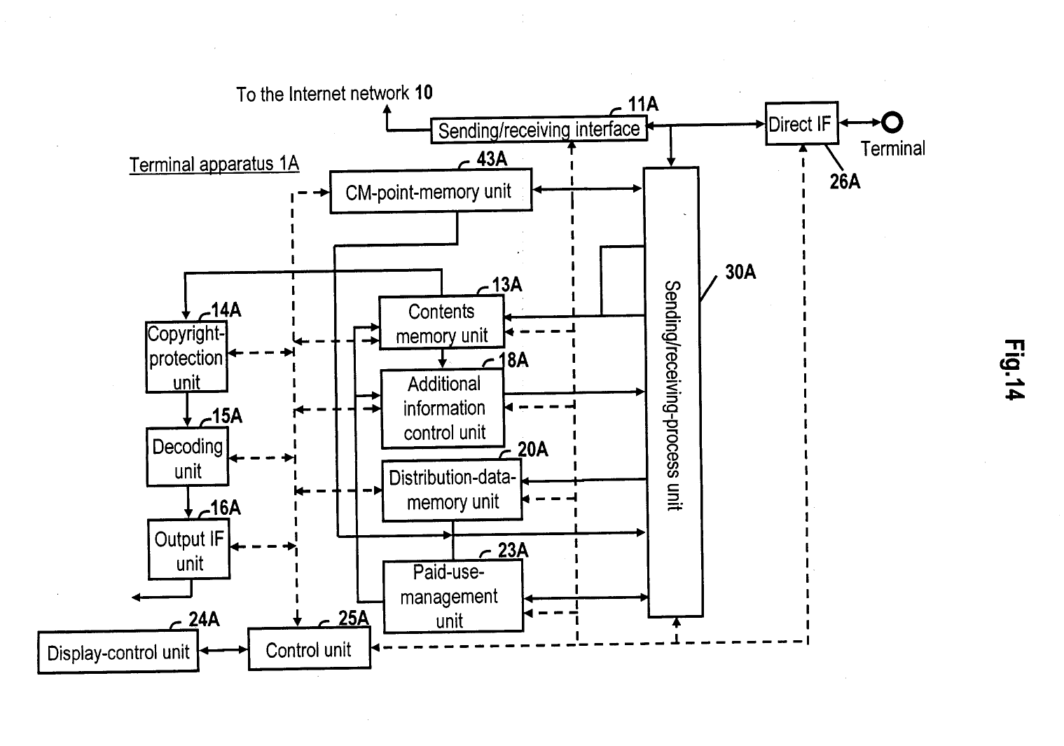

FIG. 14 is a block diagram of another example of the main components of the terminal apparatus used in this invention. In FIG. 14 the sending/receiving processing unit 30A combines a contents-receiving unit 12A, personal distribution sending unit 17A, distribution data receiving unit 19A, distribution-data-sending unit 21A, paid-use-sending/receiving unit 22A, CM-sending/receiving unit 40A, CM-receiving unit 41A and CM-management-sending/receiving unit 42A that were explained in the embodiment described above, and combines all of the processes of each sending/receiving unit related to sending and receiving data between the distributor and terminal apparatus. The sending/receiving interface 11A establishes communication lines with the outside.

(5-2) Embodiment 11 of the Electronic Distribution System and Apparatus

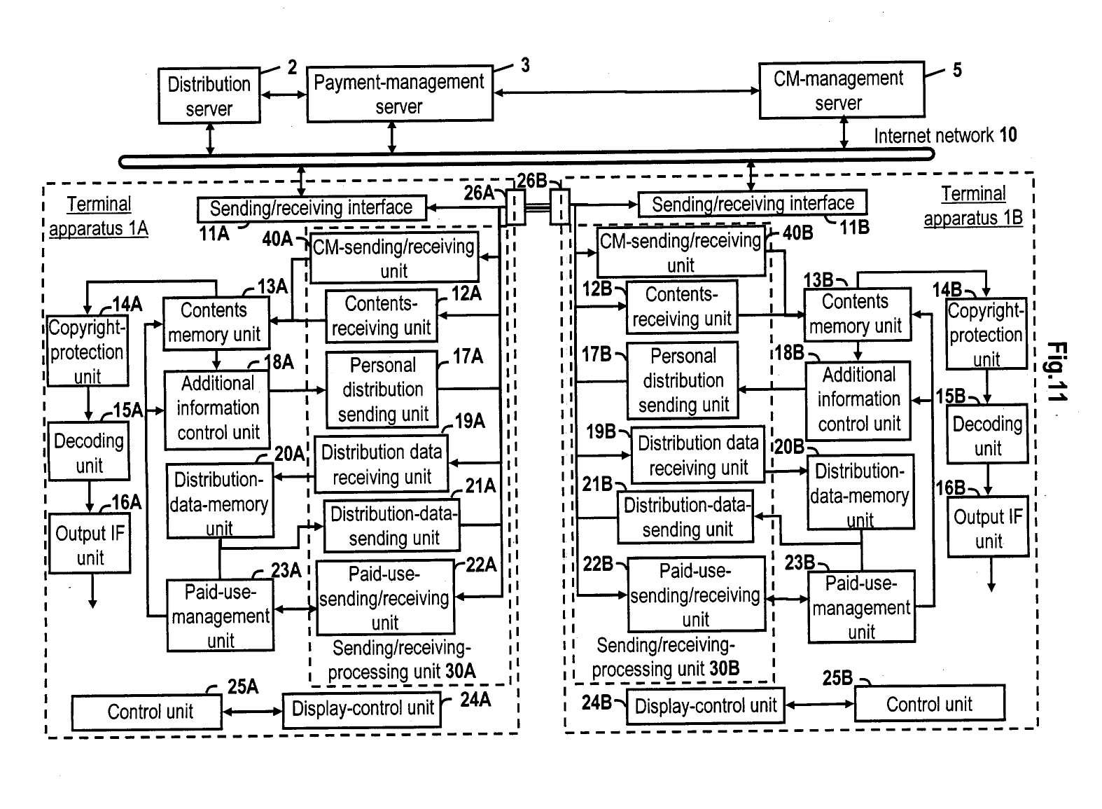

FIG. 11 is a block diagram of an eleventh embodiment of the electronic distribution system of this invention. The following explanation will center on the parts that differ from the embodiment shown in FIG. 10. In FIG. 11, the distribution data management server 4 is omitted. There is a direct interface 26A in terminal apparatus 1A, and there is a direct interface 26B in terminal apparatus 1B. Direct interface 26A can be connected to direct interface 26B by a cable, for example.

Personal distribution from terminal apparatus 1A to terminal apparatus 1B is performed between direct interface 26A and direct interface 26B. When performing personal distribution, user A uses the display-control unit 24A to enter the song title M from among the contents in the contents memory unit 13A that user B desires. Control unit 25A reads the container from the contents memory unit 13A that contains the contents of song M, and the additional information control unit 18A sets the payment flag to ‘0’, and gives the container to the personal distribution sending unit 17A. The personal distribution sending unit 17A outputs the container to the direct interface 26A.

At terminal apparatus 1B, the direct interface 26B receives the container and identifies the received contents and detects that the contents is the song, then gives the container to the contents-receiving unit 12B. The contents-receiving unit 12B receives the container and stores it in the contents memory unit 13B. Similar to as was done in embodiment 4, after receiving the contents, user B performs the proof of purchase process for paying for the personally distributed contents.

As was don in embodiment 4, the payment-management server 3 reports the purchase record for the ordered song, performs the procedure for withdrawing payment from the bank account of user B, and returns the payment-complete key K for the ordered song. Terminal apparatus 1B issues the sales points so there is no need for the distribution data management server 4.

When terminal apparatus 1B receives the payment-complete key K from the payment-management server 3, the control unit 25B changes the payment flag from ‘0’ to ‘1’, then instructs the distribution-data-sending unit 21B to issue sales points and outputs the points from the direct interface 26B. The sales points are sent after the payment-complete key K has been received, so improper state occurs such as obtaining sales points with no record of payment. When CM points are issued together with the sales points, control unit 25B has the distribution-data-sending unit issue and send the CM points.

After terminal apparatus 1A, by way of direct interface 26A, receives the sales points and CM points that were sent from terminal apparatus 1B, the direct interface 26A detects that the received contents are sales points and CM points, and gives the received contents to the distribution data receiving unit 19A. The distribution data receiving unit 19A stores the received sales points and CM points in the distribution-data-memory unit 20A. Storage is such that the newly received sales points are added to the previously stored sales points.

The other operation of this embodiment is performed in the same way as explained for embodiment 4.

Communication between terminal apparatus 1A and terminal apparatus 1B can be performed by close-range wireless communication. With this embodiment, as in the case of embodiment 4, an increase in sales due to personal distribution can be expected. Since communication is not by way of an Internet service provider, there are no service fees for the Internet service provider. With a cable connection, there is also no need for performing work such as specifying the address of the other terminal apparatus as in the case of using e-mail. Furthermore, the distribution data management server 4 is also unnecessary. User A and user B must bring terminal apparatus 1A and terminal apparatus 1B together to perform personal distribution, however, the system can be simplified.

(5-3) Embodiment 12 of the Electronic Distribution System and Apparatus

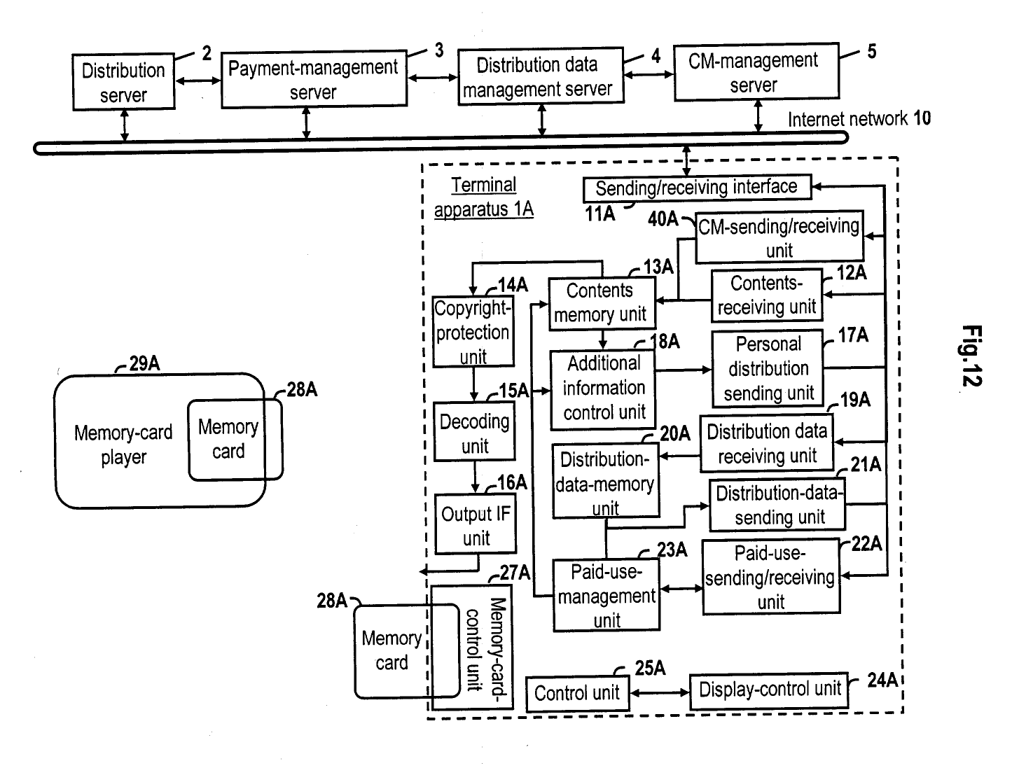

FIG. 12 is a block diagram of a twelfth embodiment of the electronic distribution system of this invention. In FIG. 12, in addition to that of embodiment 4, the terminal apparatus 1A has a memory-card-control unit 27A.

When a memory card 28A is inserted into the memory-card-control unit 27A, the control unit 25A transfers the contents of the contents memory unit 13A to the memory card 28A by way of the memory-card control unit 27A. The memory card 28A can be inserted into a memory-card player 29A to play the contents. By equipping the memory-card player 29A when a memory-card-reading-control unit, as well as a copyright-protection unit 14A, decoding unit 15A, output IF unit 16A and control unit 25A that are the same as those of the terminal apparatus 1A, it is possible to play the same CM and music contents as terminal apparatus 1A. Terminal apparatus 1A can be a personal computer that is capable of recording data on a memory card.

(6) Distribution Log Data

FIG. 15(A) and FIG. 15(B) explain the additional Information. The additional-information area 504 stores the distribution log data together with the payment flag. The ID of past users who purchased the contents, are stored in the distribution log data. In the case of terminal apparatus 1A, user A is the first user to which the distribution server 2 sent the container, so the control unit 25A of terminal apparatus 1A writes the ID of terminal apparatus 1A in the additional information of the contents stored in the contents memory unit 13A. After this container is distributed to terminal apparatus 1B by personal distribution, terminal apparatus 1B adds the ID of terminal apparatus 1B to the additional data of the distributed container. In this way, it is possible to know which user this container was distributed to or which terminal apparatus it was distributed by. Also, since the ID of the terminal apparatus is known, it is possible to perform communication with a terminal apparatus of a past personal distributor. The ID can be added when the container is received, or can be added when the container is sent.

When terminal apparatus 1B sends the proof of purchase for the personal distribution to the payment-management server 3, it also sends the distribution log data, and the payment-management server 3 gives the received distribution log data to the distribution data management server 4, which manages the distribution log. In this way, it is possible to know which songs are most often distributed by personal distribution, and to know which users perform personal distribution often, or what their preferences in music are, and thus this information can be used in marketing. For example, the information can be used in a personal-distribution promotional campaign. The information can also be used in events such as awarding special sales points from the distributor to users that have transmitted contents using personal distribution a specified number of times or more.

Also, sales points can be sent to the terminal apparatuses included in the distribution log data. In this way, the number of sales points received increases the more personal distribution is performed, so personal distribution spreads even more. Sales points can be sent from the terminal apparatus 1B, or can be sent by the distributor from the distribution data management server 4. It is also possible to create an address for the terminal apparatus of the other party based on the ID data, attach sales points to be awarded to a sales-point-sending form and send that sales-point-sending form. Since the number of sales points issued greatly increases as personal distribution becomes more popular, it becomes necessary to take into consideration measures such as gradually decreasing the value of the sales points, in order to avoid crashing the system. For example, by limiting awarding sales points to personal distributors up to only the past three generations, it is possible to prevent an explosive increase in the amount of sales points.

Moreover, by having the user B record his/her own personal information (age, sex, music preference, etc.) in the distribution log data-record area and sending it to the distributor, sales points can be sent to terminal apparatus 1B from the distribution data management server 4. By doing this, the distributor can use that information in marketing, and it is an effective way to obtain newer information than that obtained when the distributor made the distribution contract with the user B. The distribution data management server 4 can also establish a communication line with each terminal apparatus when necessary and obtain the distribution log data.

(7) Communication Between the Server and Terminal Apparatus

For communication between distribution server 2, payment-management server 3 and distribution data management server 4 and the terminal apparatuses 1A, 1B, a method of establishing a communication line using an Internet IP address can be taken. In the method, IP addresses must be prepared for the terminal apparatuses of each of the users. By having each terminal apparatus have its own IP address, communication for personal distribution can performed between terminal apparatuses without having to go through an Internet service provider, and thus there is no need to pay a fee for using an Internet service provider.

A method can be taken in which a contract with an Internet service provider is made for each terminal apparatus 1A, 1B, and after making a dial-up connection, communication is performed in the form of data transmission according to e-mail and Internet protocol, a request is sent to the Internet service provider for communication with the distribution server 2, payment-management server 3 or distribution data management server 4. Data contents necessary for communication with each server, in other words, own ID, contents, payment-complete key, sales points, ID of the other party and the like are stored in the protocol data used for e-mail and the Internet, then the address of the distribution server 2, payment-management server 3 or distribution-management server 4 is attached and the data are sent to the Internet service provider. The Internet service provider transfers the data to the servers of the distributor. In embodiment 4 of the electronic distribution system and apparatus, an example of using this kind of method in the communication for personal distribution was explained.

It is also possible for the distributor to receive the dial-up connection by phone line from the terminal apparatuses 1A, 1B, and to perform communication between the servers and the terminal apparatuses 1A, 1B. It is also possible to assemble the terminal apparatuses 1A, 1B in mobile telephones and to perform communication with the servers of the distributor by using an Internet service or e-mail service that provides a mobile telephone system. Moreover, it is possible to assemble the terminal apparatuses in personal data assistants (PDA) and to perform communication via a PDA service.

(8-1) Embodiment 4 of the Electronic Distribution Method

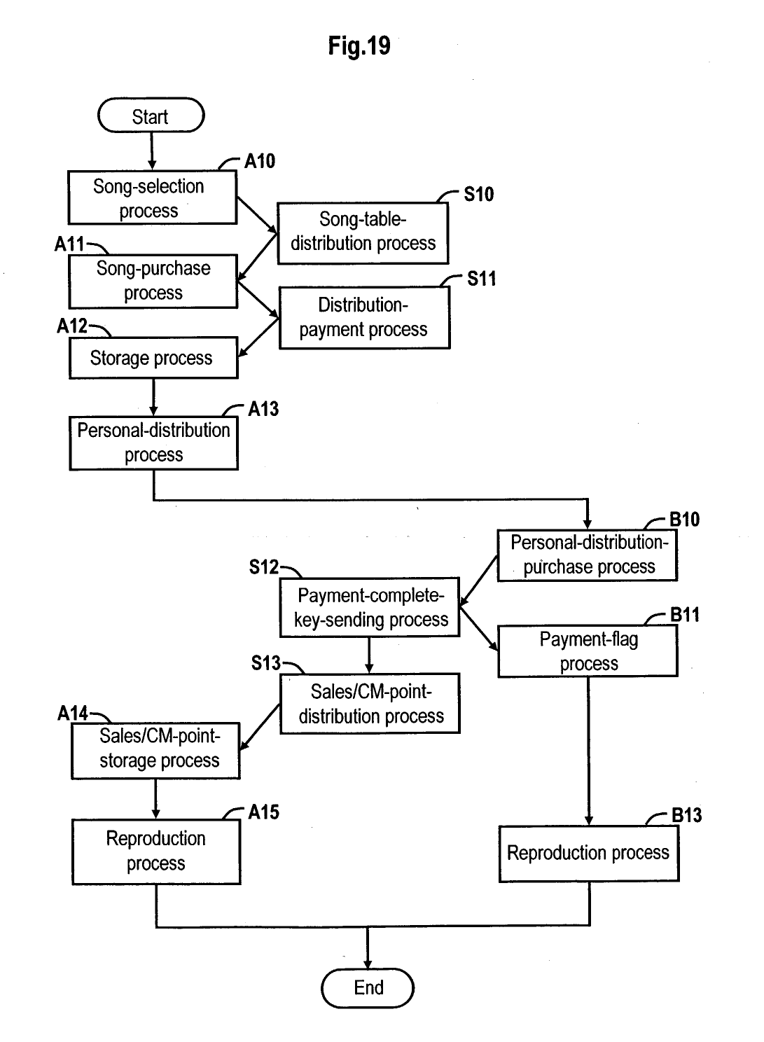

FIG. 19 is a flowchart of a fourth embodiment of the electronic distribution method of this invention, and it shows the method for the function of the electronic distribution system explained in FIG. 10. Similar to the embodiment shown in FIG. 10, the electronic distribution system comprises a distribution server 2, payment-management server 3, distribution data management server 4, CM-management server 5, Internet network 10, terminal apparatus 1A and terminal apparatus 1B.

The distributor of digital contents such as music, has the distribution server 2, payment-management server 3, distribution data management server 4 and CM-management server 5, and performs the work of distribution. The distributor makes a distribution contract with a user A having a terminal apparatus 1A, and by way of the distribution server 2, receives orders from the user A to distribute music and sends contents corresponding to a song title M to the terminal apparatus 1A of the user A. Also, a method of payment for the song M is decided upon with the user A, and the payment-management server 3 processes the payment based on the decided method and order. The distributor also makes a similar contract with a user B that has terminal apparatus 1B, and performs the work of distributing music. The distribution data management server 4 issues and manages distribution data for promoting distribution.

Also, a contract is made with a sponsor that provides CMs, and the CM contents that are provided from the sponsor are stored by the CM-management server 5, and when distributing the music contents, the CM contents are attached and supplied to the user A, and the distributor receives a sponsor fee for the CM that can be used for distribution when the user A listens to the CM.

Next, FIG. 19 will be used to explain the electronic distribution method mentioned above. In FIG. 19, the process numbers on the left (process numbers beginning with A) are processes performed by terminal apparatus 1A, the process numbers in the middle (process numbers beginning with S) are processes performed by the servers of the distributor, and process numbers on the right (process numbers beginning with B) are processes performed by terminal apparatus 1B.

When user A desires to have music distributed, he/she uses terminal apparatus 1A, and in the song-selection process (A10), sends a request to the distribution server 2 to distribute a table of songs.

In the song-table-distribution process (S10), the distribution server 2 distributes a table of songs to terminal apparatus 1A. Terminal apparatus 1A receives and displays the table of songs, and the user A selects a song title M from the table. Next, in the song-purchase process (A11), the paid-use-management unit 23A creates an order for that contains the song title M, ID of terminal apparatus 1A and the address of the distribution server 2, and the paid-use-sending/receiving unit 22A uses that form to create data according to Internet transmission protocol. The sending/receiving interface 11A establishes a communication line with the distribution server 2, and sends the order form to the distribution server 2 via the Internet network 10.

Next, in the distribution-payment process (S11), the distribution server 2 checks the ID of terminal apparatus 1A, and by way of the established communication line, stores the contents corresponding to the ordered song title M in a container and send it to terminal apparatus 1A. It attaches the CM contents at this time.

The container used in the electronic distribution method of this invention contains the contents and additional information related to the contents, and the status of the contents in the container can be set to ‘Paid’ or ‘Unpaid’, and the CM contents can be contained in the additional information or can be contained in a separate container. First, the case of indicating the ‘Paid’ status or ‘Unpaid’ status by a payment flag storing the CM contents in the additional information will be explained. The data in the container of this invention is the same as that explained in FIG. 15(A).

Terminal apparatus 1A receives the container, and then in the storage process (A12) checks the received contents and identifies the contents as a container, and when it confirms that the received contents are the contents corresponding to the ordered song title M, stores the container and notifies the distribution server 2 that ordered song M has been received. In the distribution-payment process (S11), the distribution server 2 instructs the payment-management server 3 to execute payment settlement. The payment-management server 3 executes the payment settlement procedure according to the decided method.

In order for user A to listen to the contents corresponding to the ordered song title M, he/she operates terminal apparatus 1A, and in the reproduction process (A15), terminal apparatus 1A reads the copyright information and payment flag from the stored container and checks the payment flag. Since the status of container is ‘Paid’, the payment flag is ‘1’, so the terminal apparatus 1A performs the copyright-protection process to allow playing of the song. When it is allowed to start playing the song, terminal apparatus 1A reads the CM contents from the container, uses the decoding software to decode the CM contents and outputs the audio signal of the CM. Next, terminal apparatus 1A reads the contents corresponding to song title M from the container, uses the decoding software to decode the song and outputs the audio signal of the contents. By the processes described above, the user A can enjoy listening to the music after listening to the CM. When the user desires to play the contents, the reproduction process (A15) is not limited to the location shown in the flowchart, but can be executed at an arbitrary step.

Using the same process as for terminal apparatus 1A, user B can use terminal apparatus 1B to order and purchase song M or another desired song, and then listen to that song.

In the electronic distribution system of the invention, it is possible to distribute contents between terminal apparatus 1A and terminal apparatus 1B. For example, in the case that user A and user B are friends, and user B listens to the contents purchased by user A and also desires to purchase the contents, user A can distribute the purchased contents from terminal apparatus 1A to terminal apparatus 1B. User B can then listen to the music after performing a payment procedure for purchasing the received contents.

Various methods are possible for performing personal distribution, however, here an example of using an e-mail attachment file will be explained. User A operates terminal apparatus 1A and enters the address of terminal apparatus 1B and the song title M of contents desired by user B, then in the personal-distribution process (A13), terminal apparatus 1A reads the container and sets the payment flag in it to ‘0’ to update the status of the container to ‘Unpaid’.

Furthermore, terminal apparatus 1A adds the ID of terminal apparatus 1A to the distribution log data in the container, then creates an e-mail addressed to terminal apparatus 1B and sends the container. Next, terminal apparatus 1A makes a dial-up connection to calls the contracted Internet service provider, establishes a communication line and requests distribution of the e-mail. The reason the payment flag is set to ‘0’ is to prevent illegal copying and free playing of the contents.

The personally distributed e-mail is temporarily stored by the Internet service provider. User B uses terminal apparatus 1B to make a dial-up connection with a contracted Internet service provider, and by having terminal apparatus 1B execute a process for acquiring the e-mail, the e-mail is sent to terminal apparatus 1B. After receiving the e-mail, terminal apparatus 1B, in the personal-distribution-payment process (B10), detects that the received contents is an e-mail and that the attached file is a container, then stores the container in the contents memory unit.

After receiving the contents, user B operates terminal apparatus 1B to enter the proof of purchase for the personally distributed contents. In the personal-distribution-payment process (B10), terminal apparatus 1B creates an order form that contains the song title M, the ID of terminal apparatus 1B, the address of the payment-management server 3 and the ID of terminal apparatus 1A, which is the personal-distribution source. Next, terminal apparatus 1b uses the form to create data according the Internet transmission protocol, establishes a communication line with the payment-management server 3, and sends the order form to the payment-management server 3 via the Internet network 10.

The payment-management server 3 receives the order form, and then in the payment-complete-key process (S12) it checks the ID of terminal apparatus 1B and reports the purchase record for the ordered song M to the distribution server 2. Furthermore, the payment-management server 3 performs the procedure for withdrawing payment from the bank account of user B and sends the payment-complete key K for the ordered song M to terminal apparatus 1B. The payment-complete key K allows playing of the ordered song M. Next, the payment-management server 3 sends the ID of terminal apparatus 1A, which is the source for this personal distribution, to the distribution data management server 4, and requests that distribution data for the contents, for example, sales points, be sent to terminal apparatus 1A.

In the sales-point-distribution process (S13) in FIG. 19, or by another name the distribution-data-sending process, or contents-distribution-data-sending process, the distribution data management server 4 receives the request and sends the sales points to terminal apparatus 1A. The sales points are the same as those already explained. In the case of issuing CM points, in the sales/CM-point-distribution process (S13), the distribution data management server 4 issues and sends both sales points and CM points.

After receiving the payment-complete key Km terminal apparatus 1B in the payment-flag process (B11), or by another name, the payment-data process, checks the received contents and detects that the payment-complete key K has been received, then uses the received payment-complete key K to change the payment flag in the container from ‘0’ to ‘1’. By this process, the status of the container becomes ‘Paid’.

After the payment flag changes from ‘0’ to ‘1’, it becomes possible to play the ordered song M. User B operates terminal apparatus 1B to instruct that the song M be played, and in the reproduction process (B13), terminal apparatus 1B performs a series of processes related to playing the attached CM and song M. In other words, first terminal apparatus 1B reads the copyright information and payment flag from the container and performs the copyright-protection process. Since the payment flag is ‘1’, the copyright-protection process allows that the song be played. Also, terminal apparatus 1B reads the CM contents from the container, uses the decoding software to decode the CM contents and outputs the audio signal for the CM. Next, terminal apparatus 1B reads the contents of the song M from the container, uses the decoding software to decode the contents and outputs the audio signal for song M. By the processes described above, user B is able to enjoy playing the song after or while listening to the CM.

After terminal apparatus 1A receives the sales points that are sent from the payment-management server 3, in the sales/CM-point-storage process (A14), or by another name, the distribution-data-storage process, terminal apparatus 1A detects that the received contents are sales points and stores the received sales points. Storage of the sales points can be such that the newly received sales points are added to the previously stored sales points. In the case that CM points are also sent, terminal apparatus 1A reads, stores and save those points also. Sales points and CM points can be saved separately or can be added together and saved. As has already been explained, sales points and CM points can be used by a user when ordering a new song in order to receive a discount service on the sales price.

In the song-purchase process (A11) in FIG. 19, when user A uses terminal apparatus 1A to enter the title of a desired song N, terminal apparatus 1A check whether there are any sales points or CM points remaining, and when there are points remaining, attaches the sales point or CM points to the order form. Next, terminal apparatus 1A creates a form that contains the ID of terminal apparatus 1A and the address of the distribution server 2, then sets the flag for using sales points or CM points in the sales point or CM point column of the order form and uses that order for to create data according to protocol for Internet transmission. After that, terminal apparatus 1A establishes a communication line with the distribution server 2 ands sends the order form to the distribution server 2 via the Internet network 10. Also, terminal apparatus 1A decreases the number of sales points or CM points saved in memory by the amount used.

In the distribution-payment process (S11), the distribution server 2 checks the ID of terminal apparatus 1A, and that the flag for using sales points or CM points has been set, then instructs the payment-management server 3 to subtract the sales points or CM points from the sales price and withdraw the remaining payment from the bank account of user A, then sends the contents corresponding to the ordered song N to terminal apparatus 1A.

In this way, by performing personal distribution, the user is able to acquire sales points or CM points or both and to receive a discount on the purchase of a song, so the user actively performs personal distribution with friends. For the distributor, the number of sales through personal distribution by a user can be added to the number of direct sales from the distribution server 2 to the user. The user also advertises the distributed song.

In personal distribution, contents do not need to be sent from the distribution server, so there is no need to increase the processing capacity of the distribution server 2. Also, concentrated order can be avoided so it is possible to promptly distribute ordered contents. The amount of data required for sending the payment-complete flag K from the payment-management server 3, and for sending sales points or CM points from the distribution data management server 4 is relatively less than the amount of data of the contents, so the burden on the servers is small. Therefore, the distributor is able to expect increased sales without having to increase investment in equipment such as servers.

(8-2) Embodiment 5 of the Electronic Distribution Method

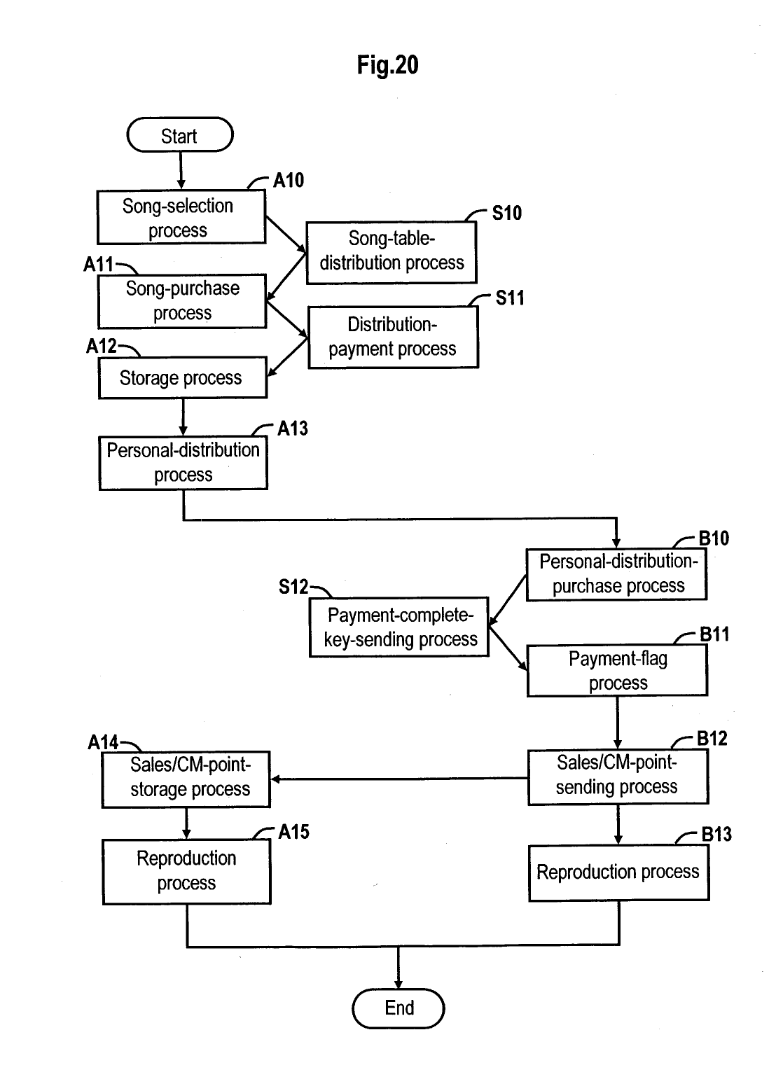

FIG. 20 is a flowchart of a fifth embodiment of the electronic distribution method of this invention. In this embodiment, the distribution data management server 4 has been omitted.

In the case of performing personal distribution, user A uses the display-control unit 24A to enter the song title of the contents desired by user B, and in the personal-distribution process (A13) shown in FIG. 20, terminal apparatus 1A reads the container corresponding to the song title from contents in the contents memory unit 13A. Furthermore, terminal apparatus 1A sets the payment flag in the container to ‘0’, adds the ID of terminal apparatus 1A to the distribution log data 505 and sends the container to terminal apparatus 1B. When terminal apparatus 1B receives the container, it identifies the received contents and detects that it is a container, then stores the container in the memory unit.

After receiving the container, user B in the same personal-distribution-purchase process (B10) as in embodiment 5 of the electronic distribution method, performs proof of purchase for the personally distributed contents.

Next, in the payment-complete-key-sending process (S12), the payment-management server 3 reports the purchase record for the ordered song in the same way as done in embodiment 5, performs the procedure for withdrawing the payment from the bank account of user B and sends the payment-complete key K that corresponds to the ordered song to terminal apparatus 1B. Since there is no distribution data management server 4, the distribution-data process, for example, sales-point process is not performed.

After receiving the payment-complete key K from the payment-management server 3, terminal apparatus 1B, in the payment-flag process (B11), or by another name, the payment-data process, changes the payment flag from ‘0’ to ‘1’ to make it possible to play the song. Also, terminal apparatus 1B in the sales/CM-point-sending process (B12), issues distribution data, for example sales points or CM points or both, and sends them to terminal apparatus 1A. Terminal 1B sends the sales points or CM points after receiving the payment-complete key K, so no improper condition occurs such as receiving sales points or CM point without a record of purchase.

After terminal apparatus 1A receives the sales points or CM points that were sent from terminal apparatus 1B, in the sales/CM-point-storage process (A14) or by another name, the distribution-data-storage process, terminal apparatus 1A detects that the received contents are sales points and stores the received sales points or CM points. Storage of the sales points is such that the newly received sales points or CM points are added to the previously stored sales points or CM points. In the case of issuing CM points, terminal apparatus 1B issues and sends sales points and CM points in the sales/CM-point-sending process (B12).

Except for the points described above, the operation is the same as that explained for the first embodiment of the electronic distribution method.

(8-3) Embodiment 6 of the Electronic Distribution Method

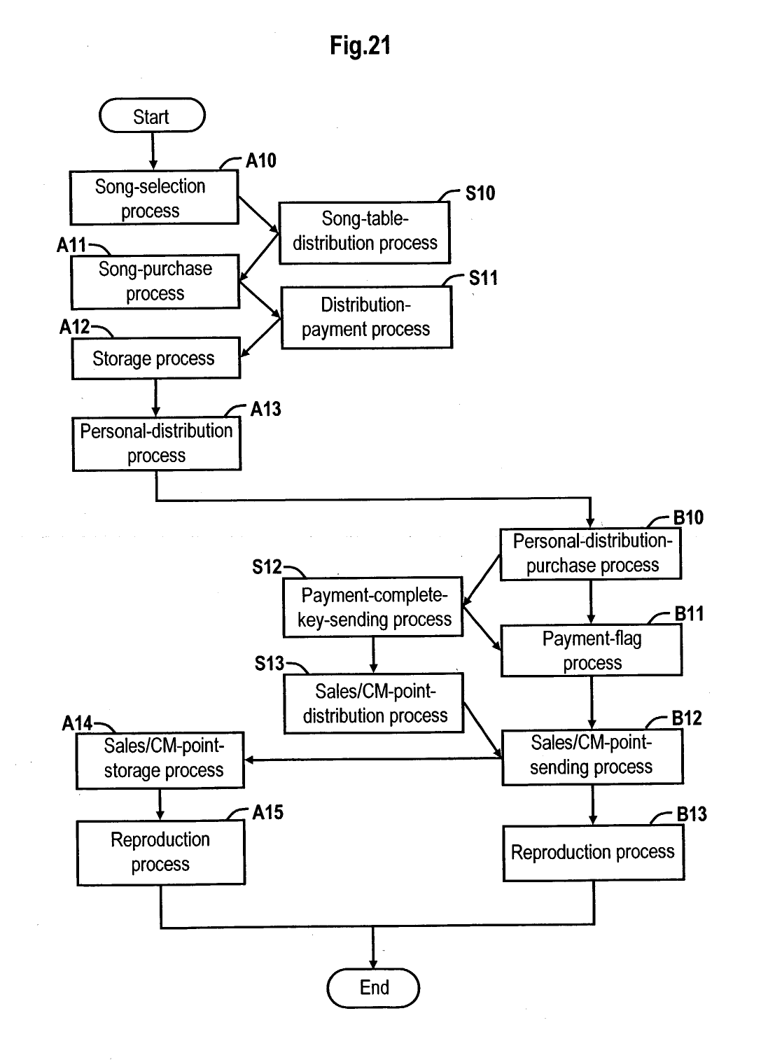

FIG. 21 is a flowchart of a sixth embodiment of the electronic distribution method of this invention. In FIG. 21, there is a distribution data management server 4, and this distribution data management server 4 issues distribution data, for example, sales points and CM points. In the sales/CM-point-distribution process (S13), the distribution data management server 4 sends sales points or CM points to terminal apparatus 1B.

Terminal apparatus 1B does not issue sales points or CM points itself, but in the sales/CM-point-sending process (B12) shown in FIG. 21, terminal apparatus 1B transfers the received sales points or CM points to terminal apparatus 1A. The other operation can be the same as the example method shown in FIG. 21. In this way, the distribution data management server 4 can handle issuing of points even when the conditions for issuing sales points or CM points change.

(8-4) Embodiment 7 of the Electronic Distribution Method

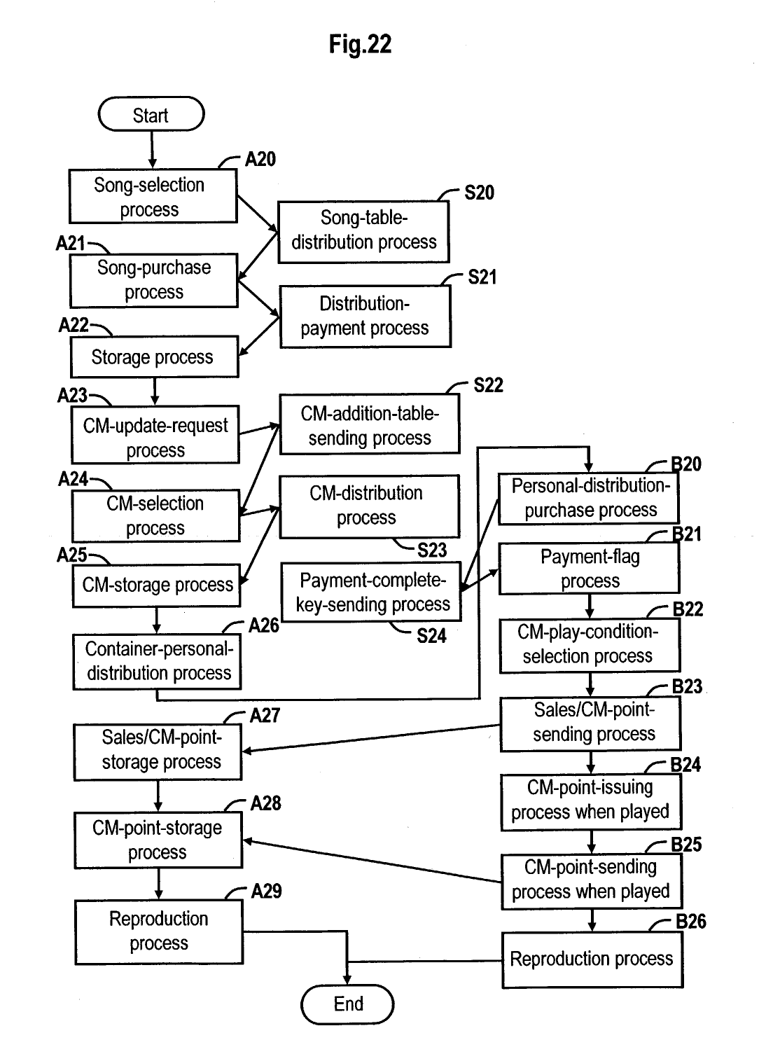

FIG. 22 is a flowchart of a seventh embodiment of the electronic distribution method of CM distribution of this invention. The CM-management server 5 comprises the same CM addition table as was explained in FIG. 16(A) and which shows the correspondence of the CM contents provided for each distributed song.

In FIG. 22, when user A desires that a song be distributed, he/she operates terminal apparatus 1A to obtain a table of songs from the distributor. In other words, after terminal apparatus 1A requests in that a table of songs be sent, the distribution server 2, in the song-table-distribution process (S20), distributes a table of songs to terminal apparatus 1A. The user A references the received table of songs, and in the song-purchase process (A21), orders distribution of a desired song from the distribution server 2. After this order has been sent, in the distribution-payment process (S21), the distribution server 2 notifies the CM-management server 5 of the ordered song M, and the CM-management server 5 selects one CM that corresponds to the song M, and gives it to the distribution server 2. The method of selecting the CM can be as already explained. Next, the distribution server 2 stores the CM contents on the CM-storage area in the additional-information area of the container, and sends the CM contents to terminal apparatus 1A together with the music contents, decoding software and copyright-protection information.

When user A operates terminal apparatus 1A to play the music, in the reproduction process (A29), using the same procedure as in the reproduction process (A15), the audio signal for the attached CM and the audio signal for the ordered song are played. The reproduction process (A29) can also be executed in any step of the operation by terminal apparatus 1A.

When user A personally distributes a song M to user B, in the CM-update-request (A23), terminal apparatus 1A creates a CM request form that contains the ID of terminal apparatus 1A and the song title M, and sends the form to the CM-management server 5. In the CM-addition-table-sending process (S22), the CM-management server 5 sends a table of CM contents, which corresponds to song M from the CM Addition Table (A) shown in FIG. 16, to terminal apparatus 1A. After terminal apparatus 1A receives the CM addition table, user A selects a CM from the CM addition table (A24).

Next, terminal apparatus 1A sends the ID of the CM selected in the CM-selection process (A24) to the CM-management server 5. In the CM-distribution process (S23), the CM-management server 5 sends the requested CM contents to terminal apparatus 1A. The CM-management server 5 keeps the CM distribution total, and increases the total by ‘1’. In the CM-storage process (A25), terminal apparatus 1A stores the received CM contents in the CM-storage area of the container that stores the CM contents. Also, in the container-personal-distribution process (A26), terminal apparatus 1A changes the payment flag from ‘1’ to ‘0’ personally distributes the container to terminal apparatus 1B.

User B receives the personally distributed container, and operates terminal apparatus 1B to purchase the contents corresponding to song M. In the personal-distribution-purchase process (B20), terminal apparatus 1B sends the ID of terminal apparatus 1B and proof of purchase information to the payment-management server 3. In the payment-complete-key-sending process (S24), the payment-management server 3 sends the payment-complete key K to terminal apparatus 1B and performs the process of withdrawing payment from the bank account of user B.

After receiving the payment-complete key K, terminal apparatus 1B, in the payment-flag process (B21) or by another name, the payment-data process, uses the payment-complete key K to change the payment flag in the container from ‘0’ to ‘1’. Then, in the case when it is possible to select the conditions for playing the CM, or in other words, the play mode, the user B, in the CM-play-condition-selection process (B22), selects the play mode. As possible CM play modes there are: 1) playing the CM only once when playing the song M for the first time; 2) playing the CM every time the song M is played; 3) selecting the number of times the CM will be played; 4) intensively playing just the CM several times; or 5) playing the CM as desired, and issuing CM points. The CM-distribution data, for example, CM points that are issued for each of these modes is determined in advance.

Next, in the sales/CM-point-sending process (B23), terminal apparatus 1B sends the sales points and the CM points set for the play mode to terminal apparatus 1A. In the case that the distribution data management server 4 sends the sales points, the distribution-management server 4 can also add the CM points to the sales points and send them to terminal apparatus 1A.

In the case of the embodiment shown in FIG. 21 where the distribution data management server 4 issues sales points and sends them to terminal 1A via terminal 1B, the distribution data management server 4 issues the CM points in addition to the sales points and sends them to terminal apparatus 1B. Terminal apparatus 1B then transfers the sales points and CM points to terminal apparatus 1A. After acquiring the sales points and CM points, terminal apparatus 1A, in the sales/CM-point-storage process (A27), or by another name, the distribution-data-storage process, adds the acquired sales points and CM points to the points that have already been acquired, and saves them.

In the method where CM points are issued each time the CM contents are played, terminal apparatus 1B, in the CM-point-issuing-at-play process (B24), or by another name, the distribution-data-issuing-at-play process, issues CM points each time the CM is played. In the CM-point-sending-at-play process (B25), or by another name, the CM-distribution-data-sending-at-play process, terminal apparatus 1B sends the CM points to terminal apparatus 1A each time that CM points are issued, or after a set number of CM points have been issued. After receiving the CM points, terminal apparatus 1A, in the CM-point-storage process (A28), or by another name, the CM-distribution-data-storage process, adds and stores the received CM points.

It is also possible for the distribution data management server 4 to issue CM points for when the CM is played. Terminal apparatus 1B notifies the distribution data management server 4 of the ID of terminal apparatus 1A and the CM play frequency record data and requests that CM points be issued for when the CM was played. The distribution data management server 4 receives the request, issues a specified number of CM points and sends them to terminal apparatus 1A.

Terminal apparatus 1A adds the acquired CM points to the sales points, sets the point column in the order form and sends the order form to the distribution server 2 to receive a discount the next time when purchasing a song. The number of sales points and CM points used is subtracted from the saved sales points and CM points.

As described above, by changing the CM contents each time personal distribution is performed, it possible to provide the latest CM and prevent providing old, out-of-date CMs. Also, through negotiation between the music distributor and CM provider, it is possible to select CM contents that are suitable for a song.

In this embodiment, and example of terminal apparatus 1A performing personal distribution of a container after updating the CM contents was explained. Next, another embodiment of updating the CM contents will be explained. First, the CM-update-request process (A23), CM-addition-table sending process (S22), CM-selection process (A24), CM-distribution process (S23) and CM-storage process (A25) in FIG. 22 are omitted.

In the case of terminal apparatus 1A performing personal distribution, in the container-personal-distribution process (A26), terminal apparatus 1A removes the CM contents from the additional information and sends the container without CM contents to terminal apparatus 1B. Terminal apparatus 1B performs the payment process with the payment-management server 3, and in the payment-complete-key-sending process (S24), the payment-management server 3 distributes new CM contents from the CM-management server 5 to terminal apparatus 1B at the same time it notifies terminal apparatus 1B that payment is complete. Terminal apparatus 1B receives the payment-complete notification and CM contents, and in the payment-flag process (B21), terminal apparatus 1B stores the received CM contents in the already received container and updates the payment flag. In the reproduction process (B26), terminal apparatus 1B plays the updated CM contents when playing the song M.

As was previously explained, the method can be such that the CM-management server 5, terminal apparatus 1B or user B selects and sets the CM contents to be distributed to and received by terminal apparatus 1B from a CM list of a plurality of CM contents that correspond to song M.

In order for this, processes that are the same as the CM-update-request process (A23), CM-addition-table sending process (S22), CM-selection process (A24), CM-distribution process (S23) and CM-storage process (A25) in FIG. 22 are executed between the payment-complete-key-sending process (S24) and payment-flag process (B21), and between terminal apparatus 1B and the CM-management server 5, the attached CM contents are selected, set, distributed and stored.

Next, another embodiment will be explained in which updating of the CM contents is performed by terminal apparatus 1B. As described, the container used in this invention contains the music contents and additional information related to the contents., and the status of the contents can be set as ‘Paid’ or ‘Unpaid’. Also, the container can be such that CM contents are contained in the addition information or contained in a separate container. For this kind of container, the CM contents are stored in a separate container and not stored in the additional information.

When personally distributing the contents corresponding to the song M, terminal apparatus 1A removes the separate container and does not send the CM contents. On the other hand, after receiving the personally distributed contents, terminal apparatus 1B performs the procedure for paying for the song M. At the same time that the payment-management server 3 notifies terminal apparatus 1B that payment is complete, it stores the new CM contents from the CM-management server 5 in a separate container and distributes the container. Terminal apparatus 1B receives the payment-complete notification and the separate container in which the CM contents are stored, then stores the received separate container and updates the payment flag of the container. As already explained, terminal apparatus 1B plays the updated CM contents when playing the contents corresponding to song M.

In order to do this, the CM-update-request process (A23), CM-addition-table sending process (S22), CM-selection process (A24), CM-distribution process (S23) and CM-storage process (A25) in FIG. 22 are omitted.

In the case where terminal apparatus 1A performs personal distribution, in the contents-personal-distribution process (A26), terminal apparatus 1A removes the separate container in which the CM contents are stored and sends the container as is with no CM contents to terminal apparatus 1B. Terminal apparatus 1B performs the payment process with the payment-management server 3, and in the payment-complete-sending process (S24), the payment-management server 3 notifies terminal apparatus 1B that payment is complete, and at the same time places the new CM contents from the CM-management server 5 in a separate container and distributes the container to terminal apparatus 1B. Terminal apparatus 1B receives the payment-complete notification and the separate container, and in the payment-flag process (B21), terminal apparatus 1B stores the received CM contents and updates the payment flag. In the reproduction process (B26), terminal apparatus 1B plays the updated CM contents when the song M is played.

As previously explained, it is also possible for the CM-management server 5, terminal apparatus 1B or user B to select and set CM contents from a CM list of a plurality of CM corresponding to song M as the CM contents to be personally distributed to and received by terminal apparatus 1B.

In order for this, processes that are the same as the CM-update-request process (A23), CM-addition-table sending process (S22), CM-selection process (A24), CM-distribution process (S23) and CM-storage process (A25) in FIG. 22 are executed between the payment-complete-key-sending process (S24) and payment-flag process (B21), and between terminal apparatus 1B and the CM-management server 5, the attached CM contents are selected, set, distributed and stored. In order to distribute the CM contents a separate container is used.

(8-5) Application Example of the Embodiments of the Electronic Distribution Method

In (8-1) to (8-4), the basic processes of the electronic distribution method were explained. Various methods are possible for detail processes. Those will be explained below.

(8-5-1) Selecting and Setting CMs

It is possible to have a plurality of CM contents attached to the song M. In order to do this, a plurality of CM storage areas, or in other words, CM(X) are created in the container contents. When playing a plurality of CMs, it is possible to select that all CMs are played each time, or that they are played one at a time in order, etc. Also, it is possible for terminal apparatus 1B to check the number of attached CM contents and to send CM points for just that number.

In the case that the CM-management server 5 automatically determines the CM for the song M, there is no need for the CM-update-request process (A23), CM-addition-table-sending process (S22) or CM-selection process (A24). Also, it is possible to have terminal apparatus 1A select the CM according to set rules. In this case, the user A does not perform the CM-selection process (A24), but it is performed by the terminal apparatus 1A. Moreover, it is possible to determine a selection frequency ratio or probability for each CM in the CM list and to automatically select a CM according to the sponsor fee this is paid or that will be paid.

It is also possible for the CM-management server 5 to have a table of the data of CM Addition Table (C) in FIG. 17, and to reference that table when distributing CM contents. After receiving an order for the song of music contents ID1 the CM-management server 5 selects a CM from among CM(a), CM(c), CM(x) and CM(y) according to the respective addition frequency ratio, and attaches the CM to the contents. When attaching the CM contents data for the CM-ID, number of times the CM is to be played, CM time, CM period and number of CM points are stored in the CM-control-data area 1801 in the container as shown in FIG. 18. The number of times the CM is added is totaled for each CM and stored in memory, and when a CM is added the number is increased by one.

CM-addition table (B) shown in FIG. 16, and CM-addition table (C) shown in FIG. 17, has an upper limit for the total number of times each CM can be distributed, however, it is also possible to not have an upper limit. In FIG. 17 the addition frequency is the addition ratio, and in the case of music contents ID1, the addition ratios for four CMs are set. For example, the addition ratios for CM(a), CM(b), CM(x) and CM(y) are 12.5%, 6.25% 18.75% and 62.5% respectively, and the CMs are attached to the music contents ID1 using the same ratios. The distribution data management server 4 totals and stores in memory the number of times each CM is distributed and the sponsor pays the sponsor fee for the number of times the CM is distributed. The sponsor fee is not limited to the same fee per distribution, but can be changed according to the play frequency, CM time CM period or number of CM points.

(8-5-2) CM Reproduction Process for Terminal Apparatus 1A and Terminal Apparatus 1B

Terminal apparatus 1A reads the CM-ID of the CM control data, the number of times the CM is to be played, CM time and CM period data from the container after receiving the contents, and saves them in the storage process (A22). The user instructs the terminal apparatus 1A to play the music, and in the reproduction process (A29), checks the saved number of times the CM is to be played. Since initially the number of times the CM is to be played is not ‘0’, terminal apparatus 1A plays the CM contents, and then, as already explained, in the copyright-protection process and decoding process for the music contents, it plays the music. Moreover, in the reproduction process (A29) the data for the number of times the CM is to be played is reduced by one time. It is also possible to display the length of the CM time and notify the user A. In the reproduction process (A29), the terminal apparatus 1A internally stores the CM period data, and terminal apparatus 1A compares it with the current year, month and date data, and when the CM period has expired, it does not play the CM but directly plays the music contents. When the number of time the CM is to be played becomes ‘0’, the CM is no longer played. It is also possible for terminal apparatus 1B to perform a similar process in the reproduction process (B26).

(8-5-3) Issuing and Using CM Points

It is also possible for terminal apparatus 1A and terminal apparatus 1B to divide up CM points.

For example, in the sales/CM-point-sending process (B23), ⅓ of the issued CM points are sent to terminal apparatus 1A and ⅔ are acquired by terminal apparatus 1B. Two thirds of the acquired CM points are saved in the CM-point-memory unit 43B.

In the song-purchase process (A21), terminal apparatus 1A does not have to add the sales points and CM points that are attached when ordering song N, but can attach them separately. This method can be used when the discount rate for sales points is not the same as the discount rate for CM points. This method is also necessary in the case of collecting an advertisement fee from the CM sponsor according to the number of CM points used. In order to do this, terminal apparatus 1A can store sales points and CM points separately, then create a point form and set the number of points to be used in this form and send the point form to the distribution server 2. Also, in this case, the sales points and CM points are not totaled together but must stored separately.

It is also possible to not issue CM points but to issue sales points instead. In this case, as shown in FIG. 22, in the sales/CM-point-sending process (B23), the terminal apparatus 1B adds and issues sales points equal to the value corresponding to the CM points to the original sales points, and sends the total number of sales points. In the sales/CM-point-storage process (A27), or by another name, the distribution-data-storage process, terminal apparatus 1A saves the received sales points. In process steps (B24), B(25) and (A28) as well, sales points are issued, sent and stored instead of CM points.

In the case that the distribution data management server 4 issues CM points, terminal apparatus 1B, in the personal-distribution-purchase process (B20), sends the ID of terminal apparatus 1A and CM-ID to the distribution data management server 3 by way of the payment-management server 3 and requests that CM points be issued. The distribution data management server 4 references the CM addition table and checks the number of CM points, then issues the CM points and sends them to terminal apparatus 1A.

When using a number of acquired and saved sales points and CM points, it is possible to display the number of points the display-control unit of terminal apparatus 1A, and to enter the number of points used or change the number of points used when ordering a song.

(8-5-4) Distribution Number Management, Desired CM Play Frequency and Number of CM Points Used

In personal distribution, when the terminal apparatus updates the CM each time personal distribution is performed, it is possible for the distribution data management server 4 to know the number of times a CM is distributed, so distribution of a CM in personal distribution can also be added to the number of times distribution is performed. In personal distribution, in the case where a CM that is already attached to a container continues to be distributed without being updated, when terminal apparatus 1B receives and pays for that personal distribution, in the personal-distribution-purchase process (B10), by sending the CM-ID of the attached CM to the distribution data management server 4, the CM-data-management server 4 knows that the CM has been distributed and adds ‘1’ to the number of times the CM has been distributed and saves the total.

In the case where it is possible for the user to specify the number of times the CM is played, the user's desired CM play frequency data entered by user is also sent to the distribution data management server 4. The distribution data management server 4 issues a number of CM points according to the user's desired CM play frequency data, and sends the CM points to terminal apparatus 1A, which is the personal-distribution source. Moreover, it is also possible for terminal apparatus 1B to issue CM points itself and send them to terminal apparatus 1A. The number of CM points issued can also be the same as the user's desired CM play frequency data, or can be set based on set rules that includes data given in CM addition table (C) shown in FIG. 17 or stored in the CM-control-data area 1801, such as the number of times the CM is to be added, number of times the CM is to be played, the CM time, CM period, number of CM points, etc. When the user's desired CM play frequency data is ‘0’, or in other words, when the CM is not played, it is possible to increase the fee paid by user B for the song.

The number of CM points is an index of the effectiveness of the CM. When issuing CM points in the sales/CM-point-distribution process (S13), and sales/CM-point-sending processes (B12), (B23), the CM-ID of the CM is issued, sent and stored at the same time, and when a song is purchased, the CM-ID and CM points are attached as a set. By doing this, it is possible in the payment process for the distributor to know from the CM-ID and number of CM points how many times each CM has been listened to. The source of revenue for the price discount can be collected from the sponsor in proportion to the number of times a CM has been listened to. In this case, it is preferred that a set number of points, for example 1 point, be issued for each time the CM is listened to. Also, the data in CM addition table (C) in FIG. 17 for the number of times the CM is to be listened to and the number of CM points to be awarded, does not have to be used as CM control data.

(9) Executing the Method of Generating Music

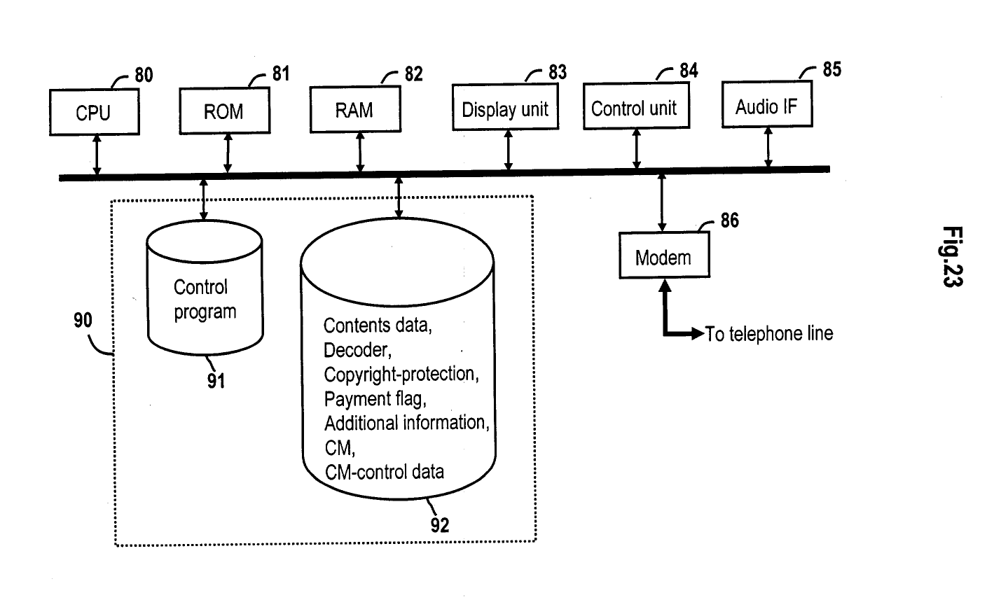

FIG. 23 is a drawing that shows the computer system for executing the electronic distribution method of this invention. In FIG. 23, a CPU 80, ROM 81, RAM 82, display unit 83, control unit 84, audio IF 85, modem 86 and hard-disc drive (HDD) 90 are connected on a bus line.

A control program 91 on the HDD 90 stores a program for each of the various control processes explained above. Containers, sales points and CM points are stored in a storage area 92 on the HDD 90.

After activating the CPU 80 using the activation program stored in the ROM 81, the CPU 80 reads the program for the procedure of each of the processes from the control program 91, and executes each of the processes explained above.

Part of the information, data and programs that are stored on the HDD 90 can also be stored in the ROM 81 or RAM 82.

(10) Another Embodiment of the Container

For this invention, an example was explained of a container that contains contents and additional information related to the contents, and is such that the status of the contents can be set to either ‘Paid’ status or ‘Unpaid’ status, and where CM contents are contained in the additional information or contained in a separate container. Another example of this kind of container, which is different from the container explained above, will be explained.

An example of using a contents key to indicated the ‘Paid’ status or ‘Unpaid’ status will be explained. In this contents-key method, the contents are encoded when sent from the distribution server. The encoded contents can be decoded with the contents key. The user receives the encoded contents, and after purchasing the contents key and decoding the contents, can play the contents.

A storage area is created in the container for storing the contents key as payment data, and it is possible to store or remove this contents key. When there is a contents key in the container, the status is ‘Paid’ status, and when the contents key has been removed, the status is ‘Unpaid’ status.

The additional information control unit 18A or 18B removes the contents key from the container, and the personal distribution sending unit 17A or 17B personally distributes the container without the contents key. The contents key is removed in the personal-distribution process (A13) and the container-personal-distribution process (A26).

Terminal apparatus 1B, in a purchasing operation, purchases the contents key from the payment-management server, then receives the contents key and stores it in the received container to set the status of the container to ‘Paid’. The contents-operation unit uses the contents key to decode the contents in order that the contents can be played. The payment-management server sends the contents key. In the payment-complete-key-sending process (S12) or (S24), the contents key is sent instead of the payment-complete key. In the payment-flag process (B11) or (B21), terminal apparatus 1B stores the received contents key in the container. In the reproduction process (A15), (B13), (A19), (B16), the contents are played after the contents key is used to decode the contents.

In yet another example of the container, a method is used by which the ‘Paid’ status and ‘Unpaid’ status can be distinguished by whether or not a contents key is attached on the outside of the container. It is possible to send the container and contents key separately.

The distribution server 2 sends the container and contents key to terminal apparatus 1A at the same time. The container and contents key are also sent at the same time in the distribution-payment process (S11). During personal-distribution by terminal apparatus 1A, the additional information control unit removes the contents key, and terminal apparatus 1A personally distributes only a container having ‘Unpaid’ status. Terminal apparatus 1A performs the same processing in the personal-distribution process (A13) and container-personal-distribution process (A26), and distributes only a container having ‘Unpaid’ status.

The terminal apparatus 1B, by the purchase operation, purchases the contents key from the payment-management server and stores the received contents key in the container in the contents memory unit 13B. The contents-operation unit uses the contents key to decode the encoded contents, so that the contents can be played. In the payment-flag process (B11) or (B21), the contents key is received and saved in the container instead of updating the payment flag. In the reproduction process (A15), (B13), (A19) or (B16), after decoding the contents using the contents key, the reproduction process is performed as already explained. In the payment-complete-key-sending process (S12) or (S24), the payment-management server sends the contents key instead of the payment-complete key K.

The structure and method of distributing CM contents has already been explained, however, in addition to the example of storing the CM contents in the additional information, it is possible to use a method of sending the CM contents separately. In addition to using a container that contains the contents and additional information related to the contents, and for which the status of the contents can be set to ‘Paid’ status or ‘Unpaid’ status, it is possible to use another container that stores the CM contents. Both containers can be sent and received together or can be sent and received separately.

As described above, in the case that the CM contents are not sent from terminal apparatus 1A, but are sent to terminal apparatus 1B in the payment process by the CM-management server 5 together with the payment-complete notification, payment-complete key K and contents key, it is also possible to use a separate container. The separate container can be used as described below.

When personally distributing a song M, the terminal apparatus 1A removes the separate container and does not send the CM contents. When terminal apparatus 1B performs the procedure for paying for the song M, the CM-management server 5 stores the new CM contents in a separate container and distributes the container at the same time that the payment-management server 3 notifies that payment is complete. Terminal apparatus 1B receives the payment-complete notification and the separate container in which the CM contents are stored, then stores the received separate container in the contents memory unit 13B and updates the payment flag.

When terminal apparatus 1B plays the contents corresponding to the song M, obtains and plays the CM contents from the separate container. In the case that the CM contents are stored and distributed in a separate container, it is preferred that CM-control data that is stored in the CM-control-data area 1801, which was explained in FIG. 18, be stored in a separate container and not in the additional information.

(11) Other Embodiments, Changes and Supplementary Explanation

When sending contents, an example of sending the song title was explained, however, it is also possible to send an ID number that identifies the song.

The contents memory units 13A, 13B can be such that they can store a plurality of containers. The terminal apparatuses 1A, 1B can be such that they are capable of selecting and playing songs from a plurality of contents and are capable of playing songs in succession.

The container stores the contents and essential additional information related to the contents, and this essential related additional information is information such as decoding software, copyright information, payment information, distribution-log information, and the like that is closely related to the contents, and when any of the additional information is removed, the contents cannot be played.

It is possible to correlate the contents with the decoding software such that when either is separately and improperly distributed it cannot be used by itself In order to do this, it is possible for the distribution server 2 to provide an ID for the terminal apparatus, ID code for the contents ID-K, and ID for the decoding software ID-D for just this distribution are set. Here, ID-D is attached to the contents and ID-K is attached to the decoding software. Each exchanges IDs, and when the exchanged ID matches its own ID, it becomes possible to perform the decoding process. As a different method, it is possible for the distribution server 2 to provide a code number for the contents and decoding software that is set for just one distribution, and is different for each distribution, and the decoding process is allowed only when the contents and the decoding software have the same code number. Since the contents and decoding software are distributed at the same time, the contents can be decoded quickly without having to take time to obtain the decoding software, even when the decoding software corresponding to the contents is not contained in the terminal apparatus.

The reproduction processes (A15), (B13), (A29), (B26) are not limited to the location shown in the flowcharts and can be executed any time when the user desires to play the music.

The distribution server 2, payment-management server 3, distribution data management server 4 and CM-management server 5 are connected by an Internet network, however, they can also be connected by the distributor LAN or by a dedicated line.

When the distributor's server charges the sponsor, it totals the sponsor fee according to the CM-control-data given in the CM addition tables (B), (C), and either the payment-management server 3, distribution data management server 4 or CM-management server 5 can send a bill for the sponsor fee. I the case of charging the fee according to the CM play mode, or record of the number of times the CM has been played, the sponsor fee can be calculated and the sponsor billed according to the CM addition table data and play record. The server can make contact with the sponsor's bank account and request the settlement procedure of withdrawing the sponsor fee.

It was explained that the distribution server 2, payment-management server 3, distribution data management server 4 and CM-management server 5 each has its own separate address, however, it is also possible to establish a uniform address for the distributor, and to identify and communicate with each respective server by using a low-order address. Also, it is possible to attach a header for identifying a server to messages sent from the terminal apparatuses 1A, 1B to the respective server.

Of the distribution server 2, payment-management server 3, distribution data management server 4 and CM-management server 5, it is possible to have some or all established in one server.

The table of distributed songs can be supplied by a paper medium such as an informational magazine or the like. In this case, it is possible to do away with the request for a table of songs in the song-selection process (A10) and also the song-table-distribution process (B10).

It is typical for the price to be different when the contents is a single song from when the contents is an album, and also the number of sales points awarded differs, so in that case, it is possible to store the number of sales points that can be awarded in the additional information in the container, and when issuing sales points, that number can be referenced to determine the number of sales points to issue.

The conditions for issuing and using sales points and CM points, and the conditions for playing CMs can be changed to meet the business plans of the distributor, so the distributor can also change the control program and control parameters in the control units 25A, 25B according to those changes.

In order to protect the container and CM contents from being stolen our change improperly, it is preferred that encoding be performed. Also, in order to eliminate the use of false names, a digital signature can be attached.

It is not especially necessary to prevent improper changing of the payment flag from ‘1’ to, however, the payment flag must be prevented from being improperly changed from ‘0’ to ‘1’. In order to do this, only when the payment-complete key K is used can the payment flag be changed from ‘0’ to ‘1’. A safe method for configuring the payment-complete flag K such that only the contents corresponding to the ordered song can be played by the terminal apparatus that ordered the song, is have the key be a combination of the ID number of the ordered song and the ID of the terminal apparatus. In the case of the contents key as well, a safe method for configuring the key is to combine the same ID codes such that the song cannot be played on another terminal apparatus and such that it is not possible to play other songs.

When sending the payment-complete key or the contents key, it is preferred that security protection be performed using a session-key method, secret-key method and public key method. Since sales points and CM points are used like money, it is preferred that the same kind of protection be performed for sales points and CM points as well. It is also possible to attach a digital signature in order to eliminate the use of counterfeit points.

In the case that the distributor uses data broadcasting, the digital contents are not provided on-demand, but a carousel method may used to repeatedly send the same digital data, and the receiver selects and acquires the desired data. In this case, the terminal apparatus can be such that it waits for the necessary container (contents) to be sent, and when the container is sent, it obtains that that data.

In the explanation above, distribution of music was explained, however the present invention can be also applied to distribution services for distributing video data such as movies, or various kinds of text or image data.

The recording medium on which the program for the electronic distribution method of this invention is recorded is a recording medium such as ROM, RAM, flexible disc, CD-ROM, DVD, memory card, hard disc, or the like on which the program is recorded. Also, the concept also includes communication media such as telephone lines or transport routes.

This invention is not limited to the embodiments described above. Here, several embodiments have been explained, including:

(1) Structure, procedure and system of attaching and distributing CM contents to contents such as music;

(2) Structure, procedure and system for a CM-management server 5, terminal apparatus or user to select CM contents;

(3) Structure, procedure and system of establishing a relationship between the number of times a CM will be added, or the ratio at which the CM will be added and the sponsor fee;

(4) Structure, procedure and system of adding CM-control data to the CM contents, and have it be reflected in the CM play mode, number of times the CM is played or issuing of CM points;

(5) System in which the user selects the CM play mode or a desired number of times to play the CM and plays the CM, and structure, procedure and system of reflecting that selection in the number of CM points issued;

(6) Structure, procedure and system of issuing CM points according to the record of number of times the user has played the CM;

(7) Structure, procedure and system of reflecting the CM-control data, desired number of times to play the CM and record of number of times the CM has been played in the sponsor fee;

(8) Structure, procedure and system of reflecting the number of CM points used in the sponsor fee;

(9) Structure, procedure and system for issuing CM points;

(10) Structure, procedure and system for personal distribution of contents to which a CM is added;

(11) Structure, procedure and system for issuing and awarding sales points in personal distribution;

(12) Structure, procedure and system for selecting a CM, the number of times a CM is to be added, CM-control data, CM play mode, desired number of times a CM is to be played, record of the number of times a CM has been played, issuing CM points, use of CM points and collecting the sponsor fee; and

(13) Security when distributing the contents, decoding software, payment-complete key, contents key, sales points, CM points etc.

In this invention, the structure, procedure and system of part or all of the items can be combined.

[Effect of the Invention]

As described above, the following items can be expected with this invention:

(1) In the work of distributing music contents, a personal-distribution route is established in addition to a supply route from the distributor, so it is possible to avoid concentrated orders, which occurs in the case of popular contents.

(2) By establishing a personal-distribution route, sales are promoted among users and thus an increase in sales can be expected.

(3) By establishing a personal-distribution route that makes it possible for a user that provides the contents to acquire sales points, the incentive for the user is increased and thus promotion of sales through personal distribution can be expected.

(4) By integrating the contents with the decoding software in personal distribution, it is possible for the terminal apparatus of the user that received the personal distribution to play the contents even though it does not contain the decoding software.

(5) In distribution work such as distributing music content, a CM is attached to the contents and distributed, so a large CM advertisement effect can be expected.

(6) Since the system and method are such that a CM can be provided, revenue from sponsor fees can be expected, and that revenue can then be utilized.

(7) A route is established for issuing and supplying CM points as an incentive to provide CMs, so it is possible to expect even more sales promotion of the contents.

What is claimed is:

1. A terminal apparatus that receives and plays distributed contents comprising:
contents memory unit operable to store a container, which contains the received said contents, and a distribution log data area that stores distribution log data capable of specifying the distribution route of the contents;
additional information control unit operable to add identification data, which is capable of identifying said terminal apparatus, in said distribution log data area as distribution log data according to specific rules; and
personal distribution sending unit operable to send said container to which said distribution log data have been added to another terminal apparatus.

2. The terminal apparatus of claim 1 wherein said container further contains CM contents.

3. The terminal apparatus of claim 2 wherein when using said container, sends identification data for another terminal apparatus that is stored in said distribution log data area to a predetermined apparatus.

4. The terminal apparatus of claim 3 further comprising a distribution data receiving unit that, based on the conditions of use for said container by said terminal apparatus or another terminal apparatus, acquires from a predetermined apparatus distribution data that is an appointment issued on promotion of the distribution of the contents.

5. The terminal apparatus of claim 4 wherein said use includes at least one of purchasing contents, playing CM contents, and distributing a container.

6. A distribution system of distributing contents to a terminal apparatus comprising:
distribution server that sends a container, which contains said contents and a distribution log data area that stores distribution log data capable of specifying the distribution route of the contents, to a terminal apparatus;
said terminal apparatus that adds identification data, which is capable of identifying said terminal apparatus, in said distribution log data area as distribution log data according to specific rules, sends said container to which said distribution log data have been added to another terminal apparatus, and sends identification data for another terminal apparatus that is already stored in said distribution log data area a distribution data management server when using said container; and
said distribution data management server that, based on received identification data for another terminal apparatus, distributes contents distribution data, which is an appointment issued on promotion of the distribution of the contents, to said other terminal apparatus.

7. The distribution system of claim 6 wherein said container further contains CM contents.

8. The distribution system of claim 7 wherein said use includes at least one of purchasing contents, playing CM contents, and distributing a container.

9. A distribution method of distributing contents from a distribution server to a terminal apparatus wherein:
said distribution server sends a container, which contains said contents and a distribution log data area that stores distribution log data that is capable of specifying the distribution route of the contents, to said terminal apparatus;
said terminal apparatus adds identification data, which is capable of identifying said terminal apparatus, in said distribution log data area as distribution log data according to specific rules, sends said container to which said distribution log data have been added to another terminal apparatus, and sends identification data for another terminal apparatus that is already stored in said distribution log data area a distribution data management server when using said container; and
said distribution data management server, based on received identification data for another terminal apparatus, distributes contents distribution data, which is an appointment issued on promotion of the distribution of the contents, to said other terminal apparatus.

10. The distribution method of claim 9 wherein said container further contains CM contents.

11. The distribution method of claim 10 wherein said use includes at least one of purchasing contents, playing CM contents, and distributing a container.

12. A program that is executed by a computer that receives and plays the distributed contents comprising:
a step of adding identification data as said distribution log data that is capable of specifying said terminal apparatus, to the received container, which contains said contents and a distribution log data area that stores distribution log data that is capable of specifying the distribution route of the contents; and
a step of sending said container, to which said distribution log data is added, to another terminal apparatus.

13. A recording medium that can be read by a computer and on which said program is recorded that is executed by the computer that receives and plays the distributed contents and comprising:
a step of adding identification data as said distribution log data that is capable of specifying said terminal apparatus, to the received container, which contains said contents and a distribution log data area that stores distribution log data that is capable of specifying the distribution route of the contents; and
a step of sending said container, to which said distribution log data is added, to another terminal apparatus.
